(19) United States
(12) Patent Application Publication
(10) Pub. No.: US 2002/0019971 A1
(43) Pub. Date: Feb. 14, 2002

(54) System and method for metaprogramming software development environment

(76) Inventors: David A. Zygmont, Alpharetta, GA (US); Wei Wang, Alpharetta, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 09/820,185

(22) Filed: Mar. 28, 2001

Related U.S. Application Data
(60) Provisional application No. 60/192,431, filed on Mar. 28, 2000.

(51) Int. Cl. G06F 9/44

(52) U.S. Cl. 717/1

(57) ABSTRACT

A meta-development environment (MDE) allows users to develop and maintain application software systems independently of architectures and to develop and maintain architecture-dependent aspects of application software systems independently of applications. The user provides the MDE with an object model expressed in an object modeling computer language and a set of one or more metaprograms expressed in a computer programming language. The object model represents an application, and the metaprograms reflect a computer system architecture. The meta-machine binds the object model components to the metaprograms to generate a software system operable on that architecture.

### CROSS-REFERENCE TO RELATED APPLICATION

The benefit of the filing date of U.S. Provisional Patent application Ser. No. 60/192,431, filed Mar. 28, 2000, entitled “SYSTEM AND METHOD FOR METAPROGRAMMING SOFTWARE DEVELOPMENT ENVIRONMENT,” is hereby claimed, and the specification thereof is incorporated herein in its entirety by this reference.

### BACKGROUND OF THE INVENTION

1. Field of the Invention The present invention relates generally to software system modeling, software development tools and computer-assisted software engineering and, more specifically, to generating software code from visual models of a software system.

2. Description of the Related Art With software systems becoming increasingly complex, so is the task of creating or engineering them. Application programs for typical complex business enterprise applications, such as operating a bank, healthcare system, accounting department, payroll department or call center, can consist of hundreds of thousands of lines of code. Graphical user interfaces, networked computing, distributed object-oriented computing, transaction processing, database technology and other advances in computing have all contributed to the skyrocketing increase in program complexity. While in earlier days of computing a single programmer could effectively comprehend an entire task, envision a suitable program structure, and write all the (perhaps a few hundred or few thousand lines of) code to implement it on a computer, these tasks become unmanageable for unaided programmers as program size and complexity increase. Complex programs (which are perhaps better termed “software systems” because they can include myriad individual pieces of software) are more often written by teams of programmers working in concert and employing general engineering principles to guide the product development effort. Software development tools are used to organize a development project and integrate third- party software into the overall system to the extent such software may be commercially available and useful to the project.

An engineering principle that has long been difficult to apply efficiently to software is the construction of complex systems from pre-manufactured sub-systems and parts. The difficulty arises in part because the majority of business enterprise software systems are custom items, written by software developers to each customer's specifications. The difficulty also stems in part from the rapid advances in computer technology that require software systems to be rewritten every few years to keep up with the technology of the computing platforms on which they are run. Although the business applications themselves often remain relatively stable for years, entirely new software generally must be written to implement those applications on new platforms.

One of the goals of object-oriented (OO) programming is code re-use. It was envisioned that object classes initially created in one application development effort could later be used if a similar class were needed in another development effort. Frameworks, which are essentially collections of classes, have been developed to similarly ease the tasks of application program developers. Specialized frameworks are commercially available to software developers to aid development of specific types of software systems, such as business enterprise application software systems. Many of the advances in OO computing relate to distributed computing systems, in which objects used in a software system can be located on different computers that are connected to one another via a network. Platforms such as JAVA 2 ENTERPRISE EDITION (J2EE) from Sun Microsystems, and MICROSOFT DNA and MICROSOFT NET from Microsoft Corporation are directed to problems that software developers face in developing OO software systems for client-server environments such as the World Wide Web. (Because terminology referring to a specified “platform” is commonly used somewhat ambiguously in the art to mean both software commercially available under the specified name and a computer operating under that software, it is preferred in this patent specification to use terminology referring to a specified “architecture” to mean the complete hardware and software computer or system of computers operating under software of the specified name and any other system software, such as application server software and database software; to the extent the term “platform” may be used, it is intended to mean a subset of the architecture.) Whenever the architecture of a business enterprise's system changes significantly, the enterprise calls upon software engineers or developers to rewrite application programs to conform to the new architecture. As each newly developed platform becomes commercially available, software developers will face the task of again rewriting software systems for them to implement the same applications that had been used on the platforms that preceded them. Typically, the amount of existing or legacy code that can be re-used in developing the new software is small in comparison to the amount that must be written anew. The major cause of this inefficiency is that, despite programmers'increasing efforts to divide software (e.g., through object-oriented technology) into manageable levels of abstraction, where the higher levels represent the problem from more of a business or user perspective, leaving the lower levels to implement the more machine-dependent and routine computing functions, many of the architecture-dependent portions of the software system typically remain inextricably bound up with the architecture-independent portions.

The rapid pace of architecture development not only causes business enterprises to expend great sums of money to periodically conform their existing applications, but it also hinders the development of new applications. The initial step of merely investigating which of the myriad architectures to base a proposed application upon can account for a significant portion of the development project budget. Furthermore, architecture advances that become commercially available after the development effort is well underway can delay the project and increase its cost if it is decided that the application should support the newly available architecture.

Object-oriented software engineering has been greatly aided by the development of modeling languages. The Unified Modeling Language (UML), promulgated by the Object Management Group (OMG), has become the standard notation for describing an OO software system. (See OMG Unified Modeling Language Specification, version 1.3, Object Management Group, Inc., Needham, Massachusetts.) The UML is not tied to any specific programming language or architecture but rather defines a graphical notation for expressing concepts common to most OO languages, such as classes, associations, aggregations, inheritance and containment. The versatility of the UML allows it to be used not only as an aid to software developers in describing and modeling software systems but for other purposes as well, including as an aid to non-programmers in describing business processes and other processes. The UML is well-known to persons of ordinary skill in the art to which the invention described below pertains and is therefore not described in further detail in this patent specification.

Software development tools that build upon the UML are commercially available. RATIONAL ROSE® from Rational Software Corporation, which was involved in developing the tML standard, provides the software developer with a set of visual modeling tools for software development in client/server, distributed enterprise and real-time systems environments. Among other features, RATIONAL ROSE allows a software developer to describe and visualize a software system in the UML, model its operation, and generate portions of the software code.

Code generators are tools that software developers can use to reduce the amount of manual coding required. A code generator uses as an input a description of the application that the developer has written in some high-level language or notation and, in response, generates as an output software (source) code that implements the application. Code generators are essentially tied to specific architectures. In other words, a code generator for one architecture will generally not generate code usable on another architecture; rather, another code generator must be used to generate code usable on that architecture. Code generators are believed by some to be advantageous and helpful tools because they attempt to exploit idiosyncracies of the architecture to maximize coding efficiency. As a result, code generators typically generate code in which the architecture-independent aspects are even more closely and inextricably bound up with the architecture-dependent aspects than manually written code.

It would be desirable to provide a software development environment in which the architecture-dependent aspects of an application software system are separable from the application itself. The present invention addresses these problems and deficiencies and others in the manner described below.

### SUMMARY OF THE INVENTION

The present invention relates to a software development environment referred to in this patent specification as a meta-development environment (MDE) that allows a user to develop and maintain application software systems independently of architectures and to develop and maintain architecture-dependent aspects of application software systems independently of applications.

The MDE includes a meta-machine and a suitable user interface. The user provides the MDE with an object model expressed in an object modeling computer language, such as the Unified Modeling Language (UML), that represents an application. The user also provides the MDE with a set of one or more metaprograms reflecting a computer system architecture. Under user control, the meta-machine binds the object model components to the metaprograms to generate a software system.

The software system generated in the above-described manner is operable on a computer system having an architecture of the type reflected by the set of metaprograms and not on systems having other architectures. Nevertheless, the same object model can be used with multiple architectures. To create a software system that implements the same application on a system having another architecture, the user causes the meta-machine to bind the object model representing the application to another set of metaprograms that reflect the other architecture. The user can provide the metaprograms by writing them or obtaining them from a vendor or other source. In this manner, an application software system can be quickly and easily developed for a newly developed architecture by creating a suitable set of metaprograms reflecting the new architecture.

Conversely, the same set of metaprograms can be used with multiple object models. To create a software system that implements another application on a computer system having the same architecture as an existing system for which corresponding metaprograms exist, the user causes the meta-machine to bind the object model representing the other application to the set of metaprograms reflecting the architecture. In this manner, software developers and even persons with minimal knowledge of architectures or coding can develop new application software systems by expressing the application in the UML or other suitable object modeling language.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a process flow diagram illustrating the operation of a meta-development environment (MDE);

FIG. 2 is a schematic block diagram of a computer system programmed to operate in accordance with a MDE;

FIG. 3 is a screen display illustrating the MDE user interface;

FIG. 4 is a schematic block diagram of a MDE;

FIG. 5 is an overview of the drawing sheets with a UML diagram illustrating a meta model;

FIG. 5A is a portion of the UML diagram of FIG. 5;

FIG. 5B is another portion of the UML diagram of FIG. 5;

FIG. 5C is another portion of the UML diagram of FIG. 5;

FIG. 5D is another portion of the UML diagram of FIG. 5;

FIG. 5E is another portion of the UML diagram of FIG. 5;

FIG. 5F is another portion of the UML diagram of FIG. 5;

FIG. 6A is a portion of a flow chart illustrating loading the object model into the meta model;

FIG. 6B is a continution of the flow chart of FIG. 8A;

FIG. 6C is a continuation of the flow chart of FIGS. 8A-B;

FIG. 7 is a UtML sequence diagram illustrating preparing to execute component metaprograms;

FIG. 8 is a UML sequence diagram illustrating executing component metaprograms

FIG. 9 is a UML sequence diagram illustrating executing class metaprograms;

FIG. 10 is a UML sequence diagram illustrating compiling a metaprogram;

FIG. 11A consists of tables describing system enumerations in the meta model;

FIG. 11B is a continuation of the tables of FIG. 1 1A;

FIG. 12A consists of tables describing the class Attribute of the exemplary meta model;

FIG. 12B is a continuation of FIG. 12A;

FIG. 12C is a continuation of FIG. 12A-B;

FIG. 13A is a table describing the class AssociationRole of the exemplary meta model;

FIG. 13B is a continuation of FIG. 13A;

FIG. 14A consists of tables describing the class Component of the exemplary meta model;

FIG. 14B is a continuation of FIG. 14A;

FIG. 15A consists of tables describing the class Generalization of the exemplary meta model;

FIG. 15B is a continuation of FIG. 15A;

FIG. 16A is a table describing the class MetaClass of the exemplary meta model;

FIG. 16B is a continuation of FIG. 16A;

FIG. 16C is a continuation of FIG. 16A-B;

FIG. 16D is a continuation of FIG. 16A-C;

FIG. 16E is a continuation of FIG. 16A-D;

FIG. 17A is a table describing the class MetaObject of the exemplary meta model;

FIG. 17B is a continuation of FIG. 17A;

FIG. 18A is a table describing the class Model of the exemplary meta model;

FIG. 18B is a continuation of FIG. 18A;

FIG. 19A is a table describing the class Operation of the exemplary meta model;

FIG. 19B is a continuation of FIG. 19A;

FIG. 19C is a continuation of FIG. 19A-B;

FIG. 20 is a table describing the class Package of the exemplary meta model;

FIG. 21A is a table describing the class Parameter of the exemplary meta model;

FIG. 21B is a continuation of FIG. 21A;

FIG. 22 is a table describing the class Realization of the exemplary meta model;

FIG. 23 is a table describing the class Subsystem of the exemplary meta model; and

FIG. 24 is a table describing the class Tag of the exemplary meta model.

### DETAILED DESCRIPTION

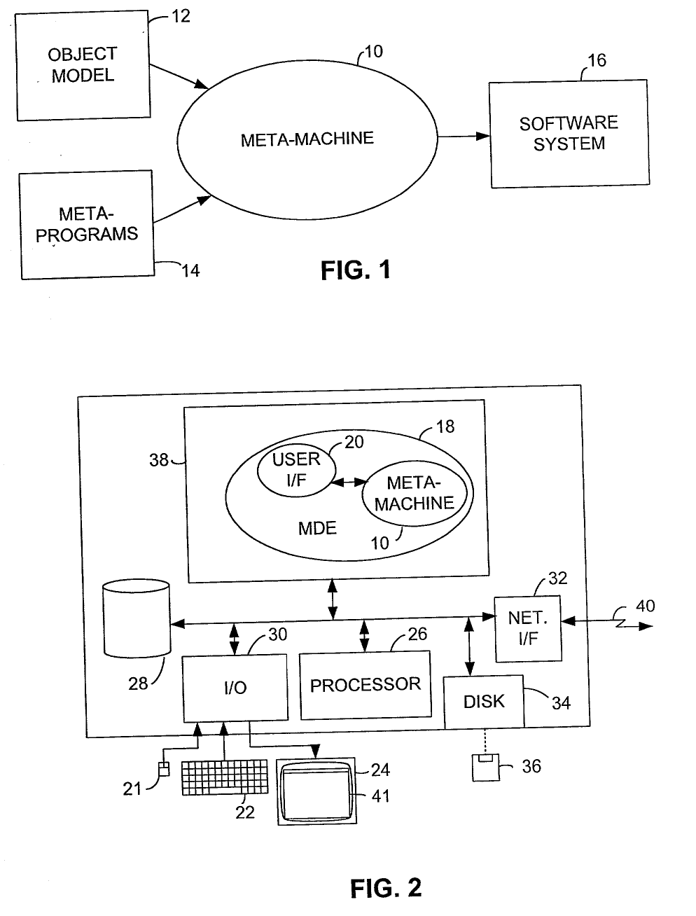

As illustrated in FIG. 1, a meta-machine 10 receives as inputs an object model 12 and a set of one or more metaprograms 14 and, in response to these inputs, produces as an output a software system 16. Software system 16 can be any portion or all of a software system operable on a computer system (not shown). An important concept underlying the invention is that architecture is separated from application. Object model 12 expresses or reflects the business logic or application logic, and metaprograms 14 express or reflect the architecture of the computer system on which software system 16 is to be operated.

The term “application” as used in this patent specification refers to the work or task to be accomplished by software system 16. The “logic” of an application is how the task is to be accomplished. Note that logic can be expressed in computer programming languages, modeling languages, mathematical notations, and other means. Software system 16 is an expression of object model 12 in a selected computer programming language, such as JAVA or any other suitable programming language. Although the present invention can be used for generating software systems 16 that address the tasks facing business enterprises such as banks, manufacturers, retailers, healthcare systems and financial and other service providers, the present invention can be used for generating software systems 16 that address tasks facing consumers and other individuals. Thus, the term “business” (e.g., “business logic” ), to the extent it is used in this patent specification, is used only for purposes of convenience and illustration.

As noted above, the term “architecture” as used in this patent specification refers to that which uniquely characterizes how the complete hardware and software computer system operates. Thus, for example, two computer systems having different operating systems or environments (e.g., MICROSOFT WINDOWS, MICROSOFT DNA, MICROSOFT .NET, JAVA 2 ENTERPRISE EDITION (J2EE), ENTERPRISE JAVA BEANS (EJB), CORBA, etc.) but otherwise having identical operating hardware and software are considered for purposes of this patent specification to have different architectures from one another. Likewise, two computer systems having the same operating system or environment but having differences in database systems or back-end servers or other operating hardware or software are considered for purposes of this patent specification to have different architectures from one another. By separating architecture from application, the present invention allows software developers or other users to create, maintain and revise an object model 12 independently of architectures of the computer systems on which a r system 16 may operate and, conversely, allows such users to create, maintain and revise metaprograms 14 independently of any application that a resulting software system 16 may implement or embody.

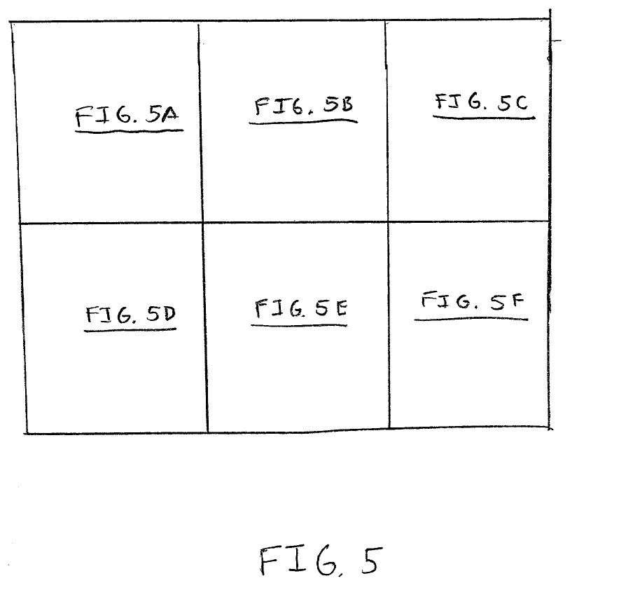

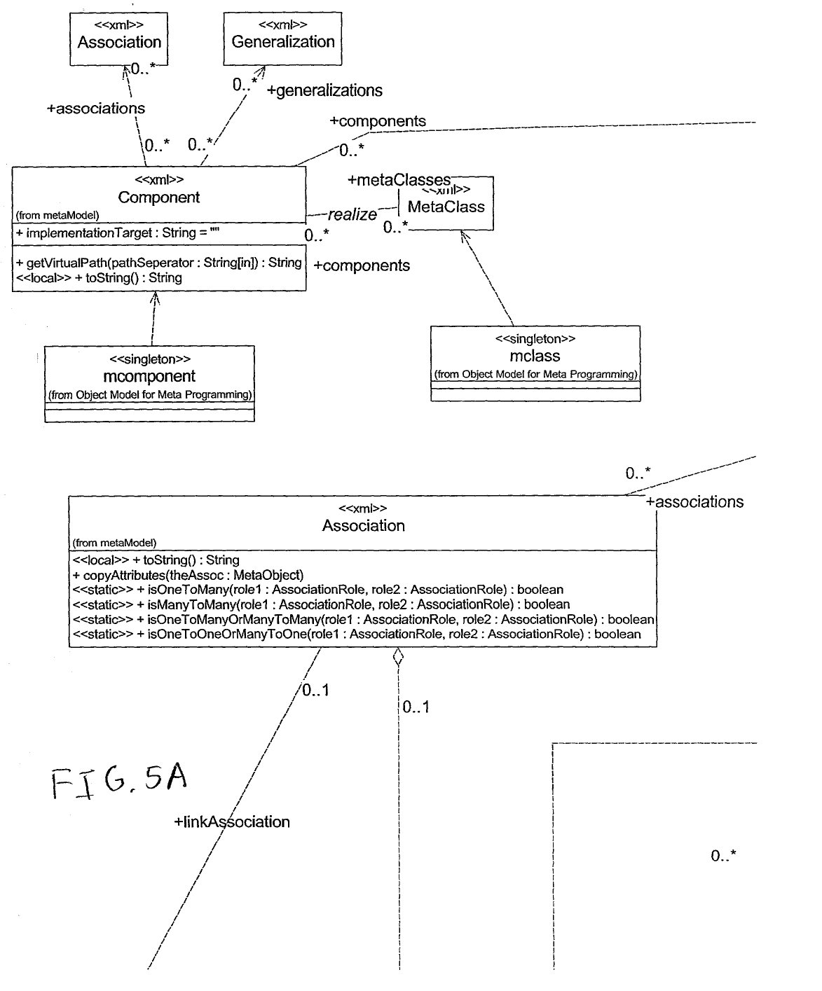

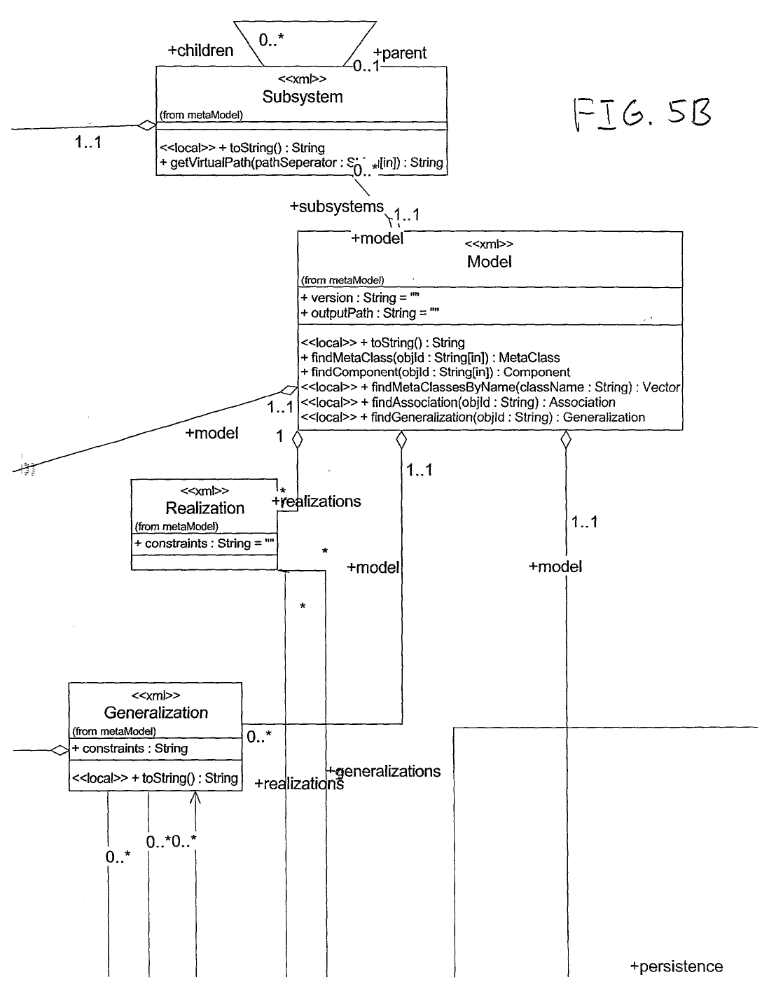

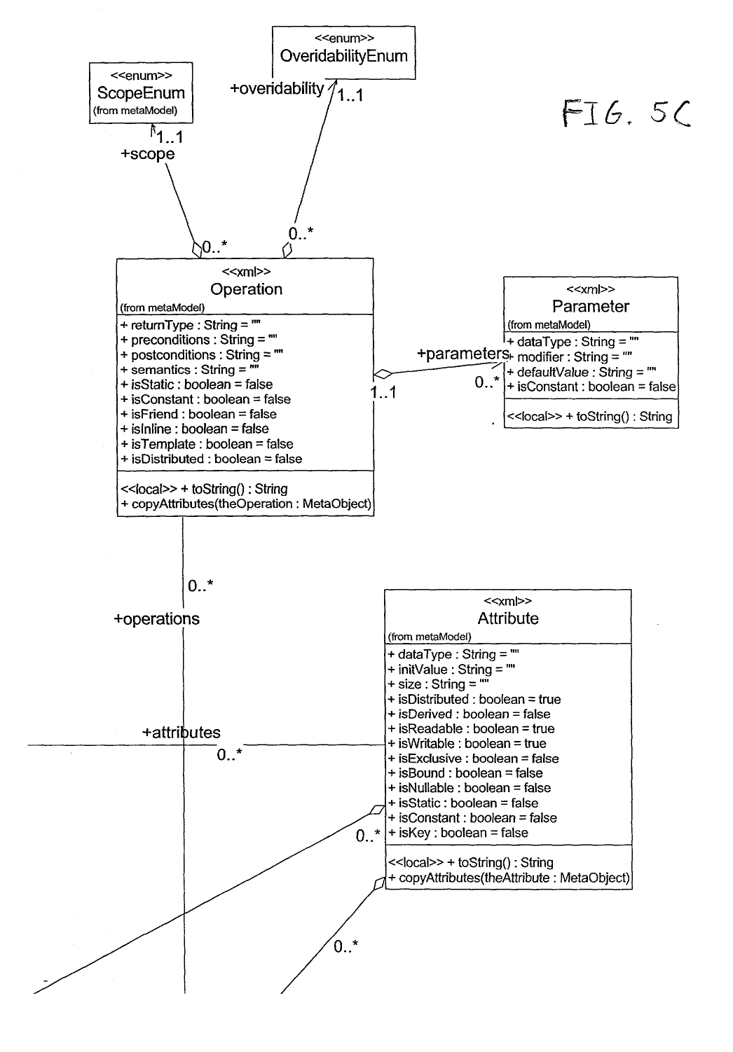

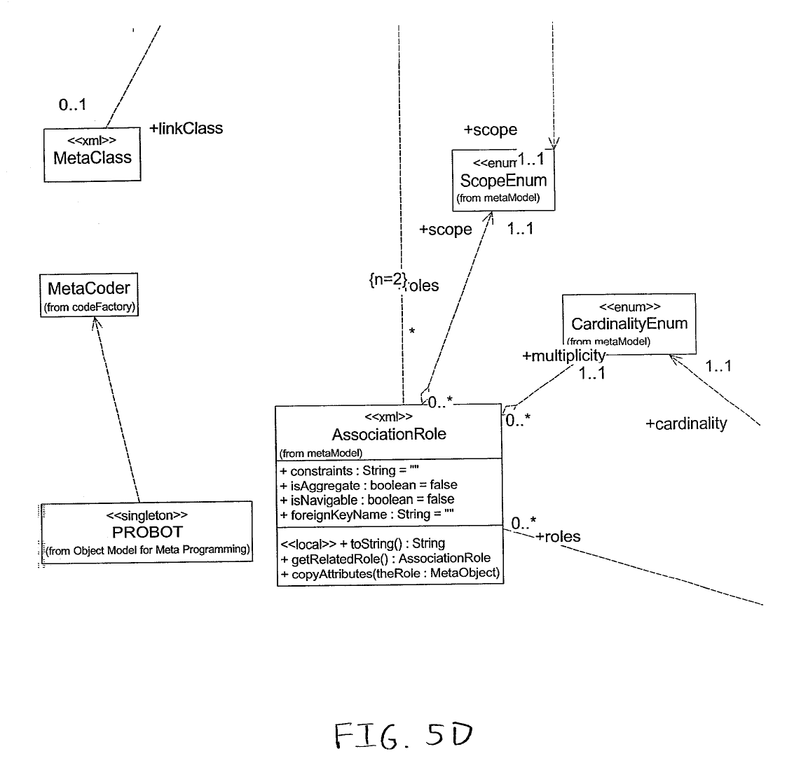

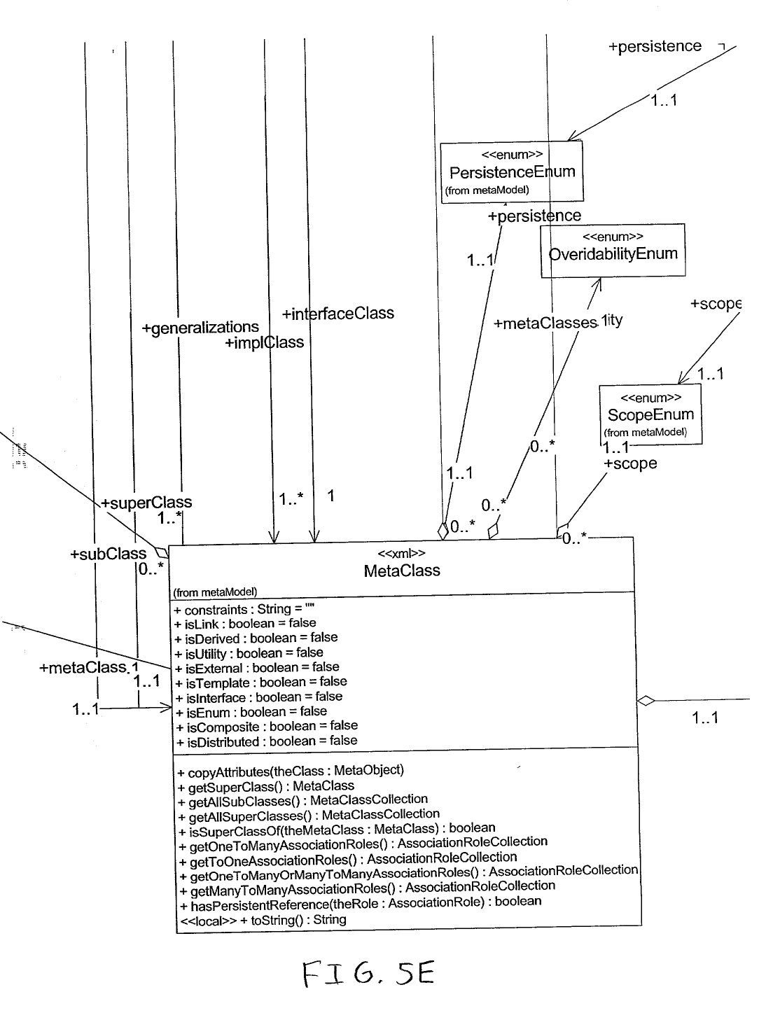

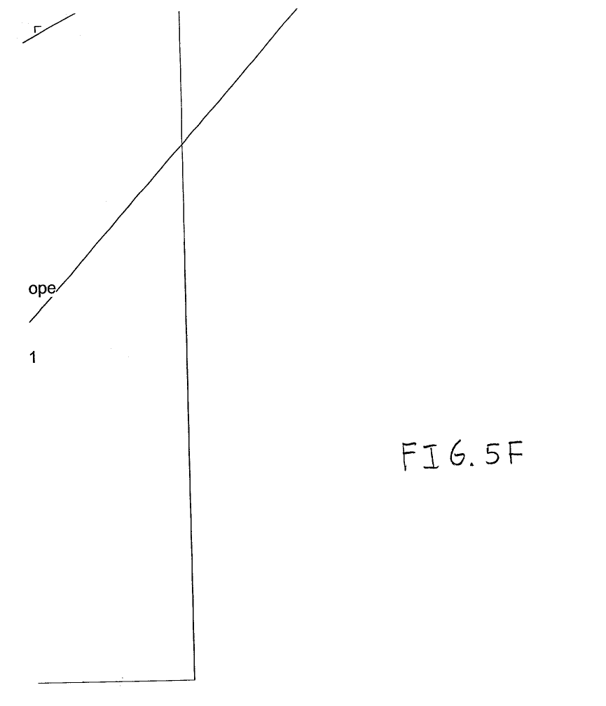

Object model 12 is expressed in a suitable object modeling computer language, such as the Unified Modeling Language (UML). As persons skilled in the art to which the invention pertains understand, UML is a visual modeling language or notation in which a software developer or other individual can express an object-oriented (OO) system. (See, e.g., FIGS. 5A-F) The UML as well as OO programming concepts are well-known in the art and therefore not described in this patent specification.

Note that object model 12 only reflects or represents software system 16; it is embodied in a modeling language and not a programming (source code) language and is therefore not operable on a computer system. In the lexicon of the UML, such an object model comprises components that realize object classes. As described in further detail below, meta-machine 10 generates a software system 16 usable on a computer system having the architecture reflected by metaprograms 14 by binding the components to metaprograms 14. Software system 16 can include source code in any suitable programming language as well as mark-up language code (e.g., HTML), database schema code, and any other software code usable on the computer system. The term “code” as used by itself in this patent specification is intended to refer to all such code. As described below, a metaprogram comprises a combination of code and metacode.

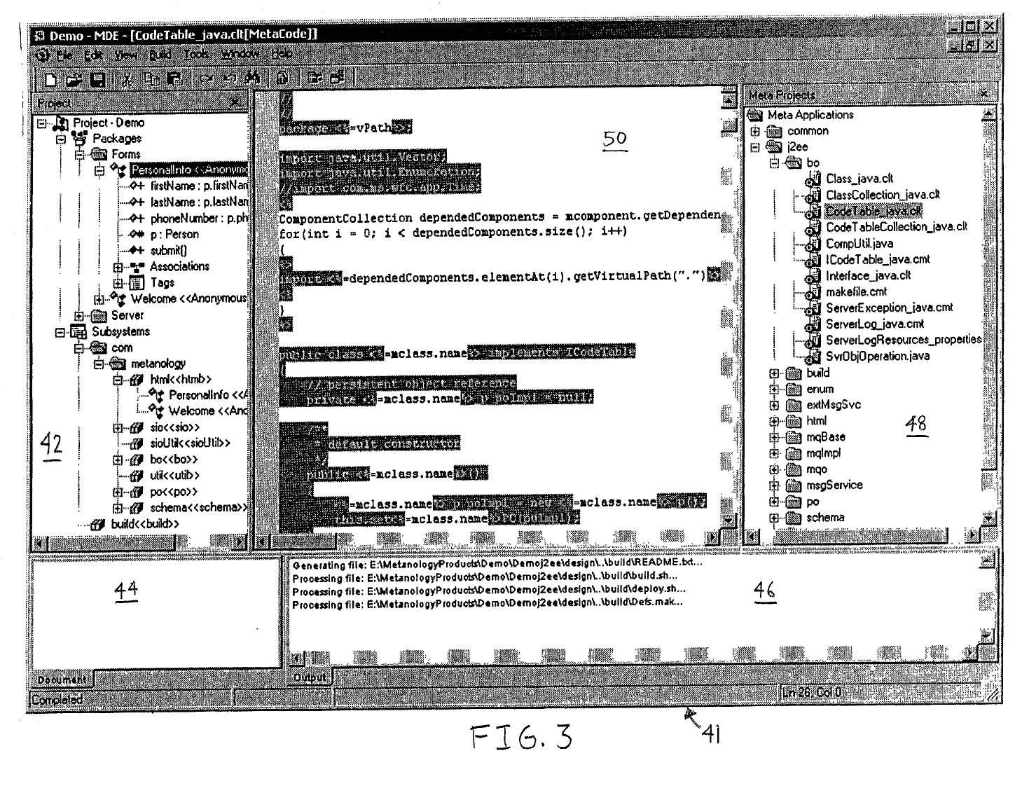

As illustrated in FIG. 2, meta-machine 10 operates under the control of a user (not shown) who is provided with a computer system on which a meta-development environment (MDE) 18 is operating, i.e., a computer system programmed with suitable MDE software. The computer or computer system operated by the user can be a conventional personal computer. As described below, MDE 18 includes a user interface 20 that operates in accordance with conventional windowing graphical user interface (GUI) paradigms. Accordingly, to interface with the user, the computer includes a mouse 21, a keyboard 22 and a video display 24. The computer also includes other hardware and software elements of the types generally included in conventional personal computers, such as a processor 26, disk storage device 28 such as a hard disk drive, input/output interfaces 30, a network interface 32, and a removable read/write storage device 34 such as a drive that uses a CD-ROM or a floppy disk 36. The software elements of the programmed computer, such as MDE 18, are shown for purposes of clarity and illustration as executable in a main memory 38, but as persons skilled in the art understand they may not in actuality reside simultaneously or in their entireties in memory 38. The computer has other hardware and software elements of the types conventionally included in personal computers, such as an operating system, but are not shown for purposes of clarity. Note that software elements such as MDE 18, object model 12 and metaprograms 14 can be loaded into the computer from another source via disk 36 or a network 40 or similar media. Similarly, such software elements can be transferred from the computer to another destination via disk 36 or network 40 or similar media. Note that embodiments of the present invention include not only methods and systems but also computer program products in which MDE 18, object model 12, metaprograms 14 or other software elements are carried on disk 36, network 40 or similar media.

Object models 12 and metaprograms 14 can be provided in any suitable manner. As described below, it is contemplated that some may be written by the user of MDE 18 or an associate of the user. Alternatively, the user or company with which the user is associated can purchase object models 12 or metaprograms 14 from a developer or other vendor of such items.

In one scenario contemplated within the realm of the invention, the individual or company using MDE 18 creates an object model 12 that reflects a business application and purchases metaprograms 14 that reflect the architecture of the company's computer system from a vendor. If the company subsequently changes or updates its computer system such that the architecture changes, the company can purchase new metaprograms 14 that reflect the new or changed architecture. Thus, object model 12 ideally need only be written once; the company can generate new software systems 16 as needed to keep pace with subsequent changes in its computer system architecture by purchasing the corresponding metaprograms from a vendor or having them written in-house (i.e., by company personnel). The invention thus addresses the fact that new architectures are being developed at a faster pace than new applications. Indeed, typical business applications such as banking, finance and accounting, tend to remain on average relatively unchanged for years while it seems that a highly-touted new architecture is introduced each year. In a scenario known to have been common in the prior art, technologists within a business enterprise would often urge a changeover to the newest architecture for performance or other technical reasons, while business personnel may have been reluctant to sanction the associated software development effort for economic reasons. Using the present invention, a changeover to a new architecture can be made relatively economically and efficiently.

In another scenario contemplated within the realm of the invention, the user or company using MDE 18 creates in-house or purchases from a vendor metaprograms 14 that reflect the architecture of the company's computer system. Once such metaprograms 14 are provided, the company can obtain any number of object models 12, either by creating them in-house or by purchasing from vendors, that reflect various business applications. When a new application is desired, the company can generate a new software system 16 by creating a corresponding object model 12 or purchasing one from a vendor. Other scenarios that involve combinations of the two described above are also contemplated.

Note that because object models 12 are not written in a programming language but rather a modeling language, even non-programmers and other non-technologically savvy individuals can create them. Thus, a company can employ business analysts or other non-technologists who are the most familiar with the application to create an object model 12. Programmers or other technologists who understand computer programming and architectures can write metaprograms 14. The business analyst or other non-technologist who creates object model 12 need not have any knowledge of metaprograms 14 or the architectures they reflect. The technologists who create metaprograms 14 need not have any knowledge of object model 12 or the business application it reflects.

A metaprogram is a mix of metacode expressed in a traditional programming language and output (code). In a metaprogram, metacode is distinguishable from the code by indicating the beginning of the metacode with an opening delimiter (e.g., the characters “<%”) and indicating the end of the metacode by a closing delimiter (e.g., the characters “%>”). For example, an example of metaprogram 14 written in JAVA and outputting hypertext mark-up language (HTML) is shown below:

<%
if (attribute.hasStereotype (“text”) {
%>

<input type=“text” name=“<%=attribute.name%>” . . .

<%
//more metacode here
%>

In accordance with the above example, when MDE 18 executes this metaprogram 14 against object model 12, the metacode causes the code to be output (to an output file) if the attribute of object model 12 has a stereotype “text” and does not cause the code to be output if the object attribute does not have that stereotype. Also note the <%=attribute.name%> construct. This is called a meta substitution and is replaced with the value of the model element to which it refers; in this case, the name of the attribute. This process is described in further detail below.

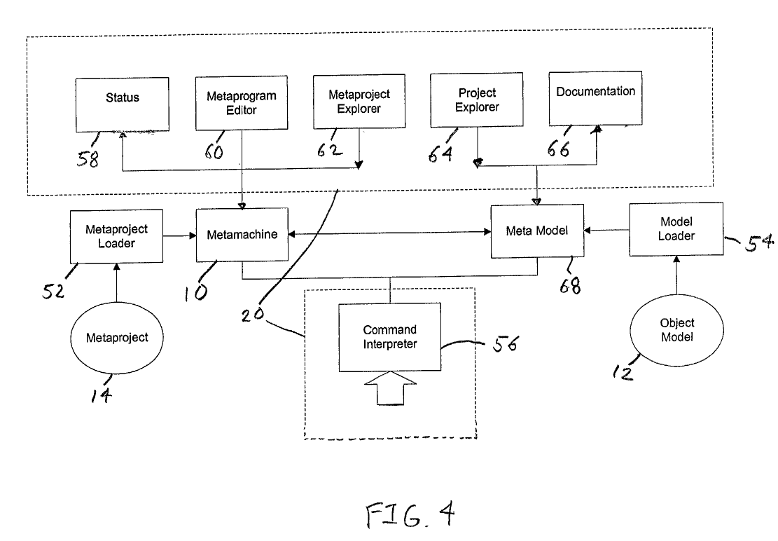

To use MDE 18, the user loads MDE 18 (e.g., via disk 36) into the computer and launches or initiates its execution in the conventional manner of an application program. As illustrated in FIG. 3, user interface 10 provides a main window via which the user can interact with MDE 18. The primary graphical elements of this window include a project explorer panel 42, a documentation panel 44, a status panel 46, a metaproject explorer panel 48 and a metaprogram editor panel 50.

Project explorer panel 42 lists one or more object models 12. Software tools for creating and editing object models are well-known and commercially available. A user can create object model 12 using such a tool and then load it into MDE 18 via disk 36, network 40 or other suitable media. Using the conventional file folder GUI concept, a graphical indication of each object model 12 loaded into MDE 18 is displayed in the form of a file folder and its name. Grouped under each file folder are the names of elements that persons familiar with object modeling will understand are commonly included in an object model: Packages, Subsystems, Associations, Association Roles, Attributes, Components, Generalizations, Meta-classes, Meta- objects, Models, Operations, Parameters, Realizations and Tags. Using mouse 21 (FIG. 2) or other means for selecting graphical elements, the user can select any element of any of the loaded object models.

Documentation panel 44 displays any documentation that may be associated with elements of object model 12. As well-known in the art, the UML convention provides a means for associating documentation with elements of an object model. Persons creating an object model 12 will therefore readily appreciate how documentation is associated with model elements without further elaboration herein.

The documentation for a selected object model element is displayed in documentation panel 44.

Status panel 46 displays the activity of meta-machine 10 and metaprograms 14. Meta-machine 10 indicates to the user the progress of its operation by outputting status messages to status panel 46. MDE 18 directs to status panel 36 certain output of metaprograms 14 indicating their progress, indicating errors, and warning of potential problems in object model 12 that prevent their successful execution.

Metaproject explorer panel 48 displays the structure of loaded metaprojects. A metaproject is a collection of metaprograms 14 that together define an architecture. Thus, it is the metaprograms 14 of a selected metaproject that meta-machine 10 binds to the selected object model 12. A user can load metaprograms 14 from an external source via disk 36, network 40 or other medium or can create them within MDE 18 as described below. Using the conventional file folder GUI concept, a graphical indication of each metaproject in MDE 18 is displayed in the form of a file folder and name. Names of metaprograms 14 are grouped under each file folder. Using mouse 21 or other means for selecting graphical elements, the user can select the metaproject into which a new metaprogram 14 is to be loaded and can select metaprograms 14 for deletion, editing, renaming, saving and so forth. Sub-folders can be created to organize a hierarchy of metaprograms 14.

The term “meta-application” can be used to refer to a set of metaprojects and can also be indicated by a file folder icon and name. A metasolution file is associated with each meta-application. The metasolution file contains the name of the associated meta-application, the names of the metaprojects in the meta-application, and the names and properties of the metaprograms in each of those metaprojects.

As noted above, there can be any suitable number and type of metaprograms 14.Examples of metaprogram output (code) can include: an implementation of software system 16 in a programming language; database schema and file formats appropriate to store persistent data of software systems; software (scripts) used to build software system 16; software used to install, maintain and remove software system 16; internal system documentation used to maintain software system 16; Application Programming Interface (API) documentation describing the programming interfaces used to program software system 16; and user documentation describing the behavior of software system 16 to users.

Although there can be any suitable number and type of metaprograms 14, in the illustrated embodiment of the invention MDE 18 recognizes four categories of metaprograms 14: component, class, model and utility. Each of metaprograms 14 is assigned one of these categories to assist MDE 18 in determining how to execute it. Nevertheless, in other embodiments of the invention metaprograms 14 can be categorized differently or not divided into categories at all.

Meta-machine 10 runs each component metaprogram in a metaproject once. Component metaprograms can generate material used by all the classes in the component that are created by the class metaprograms in the same metaproject. Utility software, software installation, build software and documentation are typical outputs of component metaprograms.

Meta-machine 10 runs each class metaprogram in the selected metaproject once for each class realized in the component bound to the metaproject. Class metaprograms can generate the implementation of a class in object model 12. They add additional attributes and operations on each class in object model 12 to accommodate the requirements of the computer architecture or platform on which software system 16 is to execute.

Model metaprograms are similar to component and class metaprograms, but rather than generating the implementation of a software system from an object model of that software system, they interpret the object model of the software system and add model elements to it. For example, a model metaprogram may create additional classes along with attributes, operations, associations, create new components, realize classes in the components and map them to metaprojects as the model metaprogram sees fit. Through a meta model, described in detail below, model metaprograms can analyze object model 12 and expand the model. The new model elements are added so that component and class metaprograms can operate on them. This permits the identification of patterns in object models so that the mechanical work of modeling the detail of the pattern is foregone.

Utility metaprograms can provide general support services to metaprograms of the other types.

The metaprojects and their metaprograms 14 are not only displayed in a manner resembling a conventional hierarchical file system of folders but are actually stored on such a file system of the computer (e.g., on disk 28). When the user issues a command to create a new metaproject, MDE 18, starting from the directory that contains the then-loaded metasolution file creates a folder of the same name as that of the metaproject. That folder stores the metaprograms 14 in the new metaproject.

Components are bound to metaprojects by the value of their implementation target. As persons of skill in the art recognize, an implementation target can be set by using the user-defined extensions of an object modeling language. Using the UML, the implementation target can be set by either the value of the implementation target tag or the component's stereotype.

When a user selects one of metaprograms 14 or chooses to create a new one, user interface 20 displays it in metaprogram editor panel 50.In panel 50 a user can view and edit the selected metaprogram 14. As an aid to the user's understanding of the displayed metaprogram 14, the user can activate a toggle command, in response to which user interface 20 causes either the metacode or the code to be highlighted, i.e., displayed in a distinguishing tone or color. In other words, if metacode is highlighted, toggling causes the code to become highlighted and the metacode to become un- highlighted. If the code is highlighted, toggling causes the metacode to become highlighted and the code to become un-highlighted. In this manner, a user can quickly and easily distinguish the code from the metacode. In FIG. 3, note that the metacode is shown highlighted.

Note that although a graphical user interface 20 is included in the illustrated embodiment of the invention, in other embodiments user interface 20 can operate in with any other suitable paradigm, such as the command line-based interface of the type included in, for example, UNIX and DOS systems.

As illustrated in FIG. 4, in addition to meta-machine 10 and user interface 20, MDE 18 includes a metaproject loader 52 and a model loader 54 for loading metaprojects (i.e., groups of one or more metaprograms 14) and object models 12, respectively, as indicated above with regard to user interface 20. Elements of user interface 20 include: a command interpreter 56 that interprets user interactions with graphical input elements such as pull-down menus, buttons and folders and other icons; a status monitor 58 that gathers and displays the above-described information in status panel 46 (FIG. 3); a metaprogram editor 60 that performs conventional text editing functions and other functions on metaprograms 14 via panel 50 (FIG. 3) as described above; a metaproject explorer 62 that performs the above-described functions via panel 48; a project explorer 64 that performs the above-described functions via panel 42; and a documentation monitor 66 that displays documentation in panel 44 as described above.

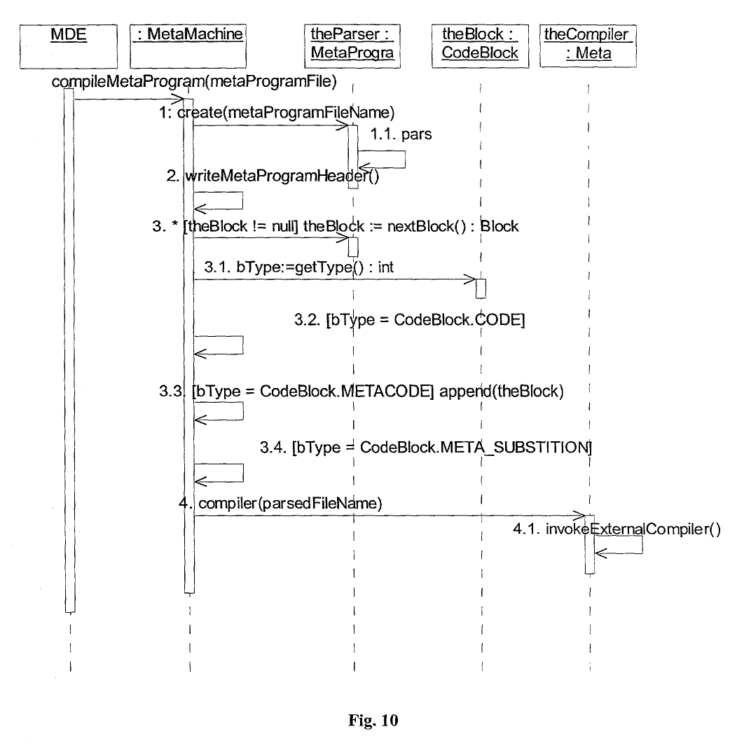

Any metaprograms 14 that are created or edited using metaprogram editor 60 or loaded from an external source in uncompiled, i.e., source code, format, they can be compiled into object code format. Metaprograms 14 are compiled into executable units of a suitable programming language such as Java. In Java, they are compiled into Java class filed. Prior to compilation they are converted into syntactically correct Java source code. As illustrated in FIG. 10 in UML sequence diagram format, the steps of converting one of metaprograms 14 into a compiled Java class include: creating a file to hold the Java source code, using the root name of metaprogram 14 concatenated with “java” as the file name, and writing the class header. The class header for component metaprograms is “class ‘root filename”’. The converting steps further include, for each block to be output into the Java source code file: determining the block's type (i.e., CODE, METACODE or META SUBSTITUTION); and, for a TEXT block, appending a call to generator. write with the quoted text block as a parameter to the Java source code file, for a METACODE block, appending the block to the Java source code file, and for a META SUBSTITUTION block, appending a call to generator.write with the block as a parameter to the Java source code file. Once all blocks have been written to the Java source code file, an external Java compiler (i.e., not considered part of MDE 18 and therefore not shown) is invoked to compile the Java source code file.

A meta model 68 is also included in MDE 18. A UML model of meta model 68 is illustrated in FIGS. 5A-F. Meta model 68 is an object model of an object model. For example, when object model 12 is loaded into MDE 18 and selected by the user, MDE 18 loads object model 12 into meta model 68. To facilitate modeling an object model, meta model 68 includes classes that represent the elements that object modelers typically include in object models. Although they may be referred to in the art by names other than the following, these object model elements include: associations, association roles, attributes, components, generalizations, classes, models, operations, packages, parameters, realizations, subsystems and tags. The corresponding class name in meta model 68 and a brief description of each class is as follows:

| | |
|---|---|
| Association | An Association instance represents an association in |
| | the object model of a software system. |
| AssociationRole | An AssociationRole instance represents an association |
| | end in the object model of a software system. |
| Attribute | An Attribute instance represents an attribute of a class |
| | in the object model of a software system. |
| Component | A Component instance represents a component in the |
| | object model of a software system. |
| Generalization | An Generalization instance represents a generalization |
| | in the object model of a software system. A |
| | generalization exists whenever one class inherits from |
| | another class. |
| MetaClass | A MetaClass instance represents a class in an object |
| | model of a software system. |
| MetaObject | The base class of most objects in the meta model. |
| Model | The root element of an object model of a software |
| | system. |
| Operation | An Operation instance represents a method of a class |
| | in the object model of a software system. |
| Package | A Package instance represents a package in an object |
| | model of a software system. |
| Parameter | A meta parameter represents a parameter to a method |
| | in the model of a software system. |
| Realization | A Realization instance represents a realization of an |
| | interface by a class in the object model of the software |
| | system. |
| Subsystem | An instance of Subsystem represents a subsystem in |
| | the model of the software system. A subsystem is used |
| | to group components and typically affects the physical |
| | layout of implementation of the software system. |
| Tag | A Tag instance represents a tagged value bound to a |
| | model element in an object model of a software |
| | system. |

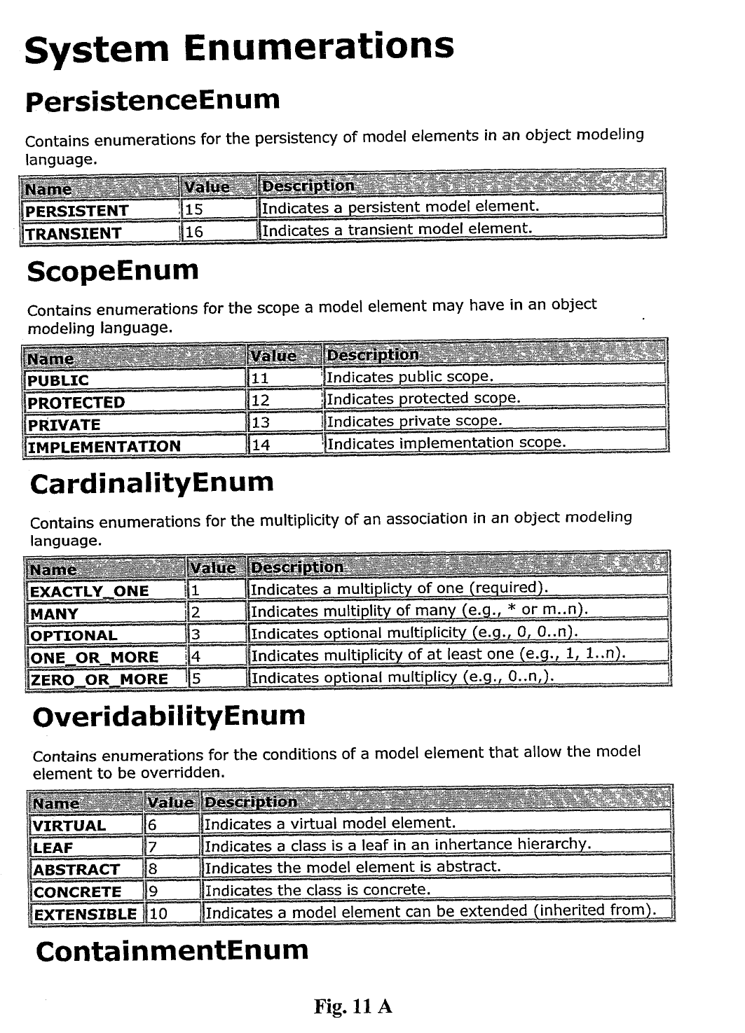

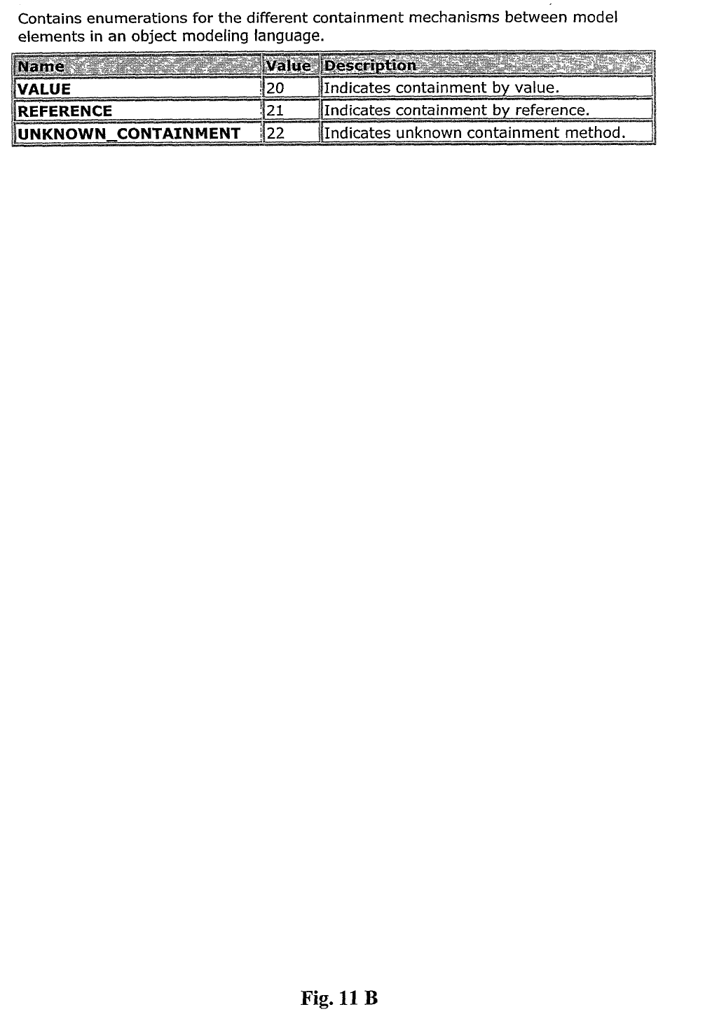

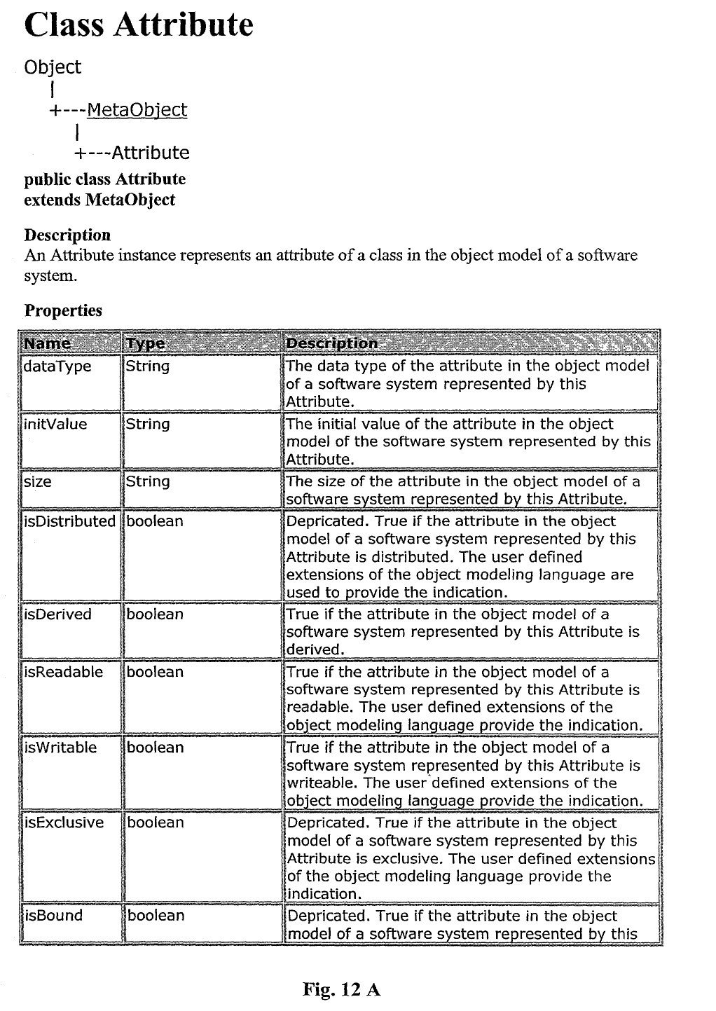

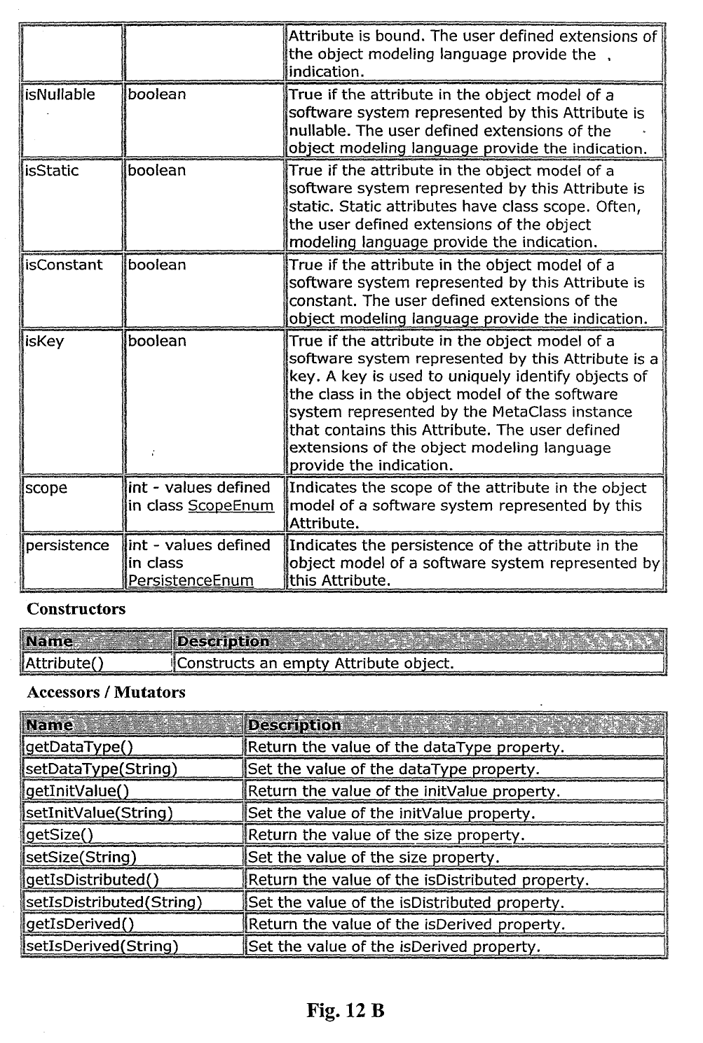

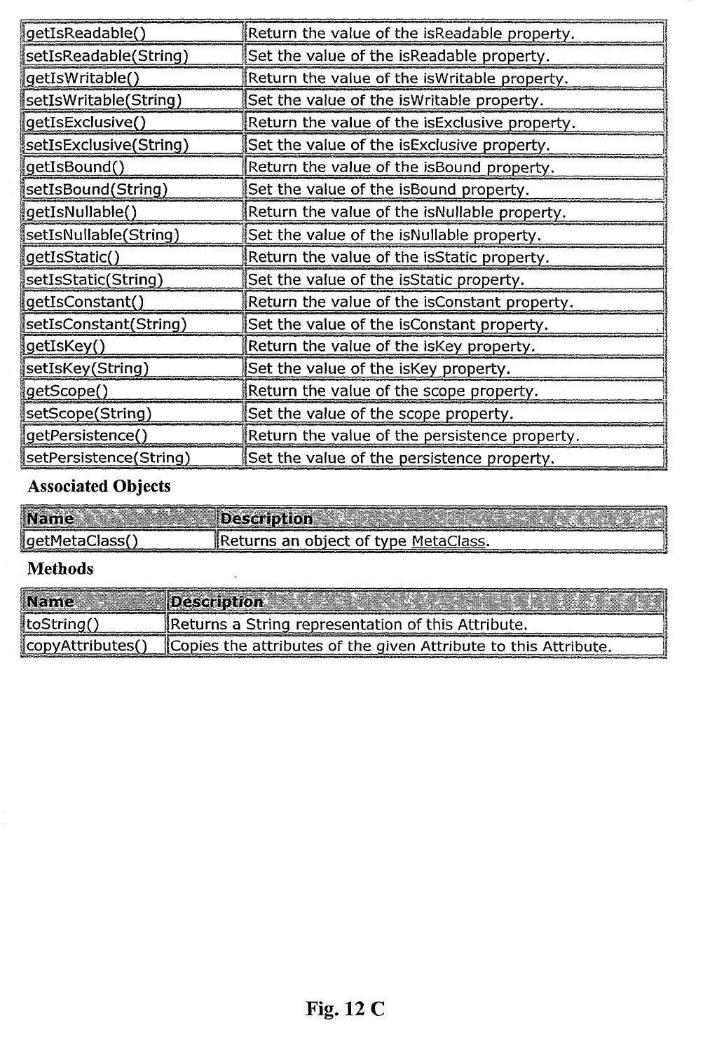

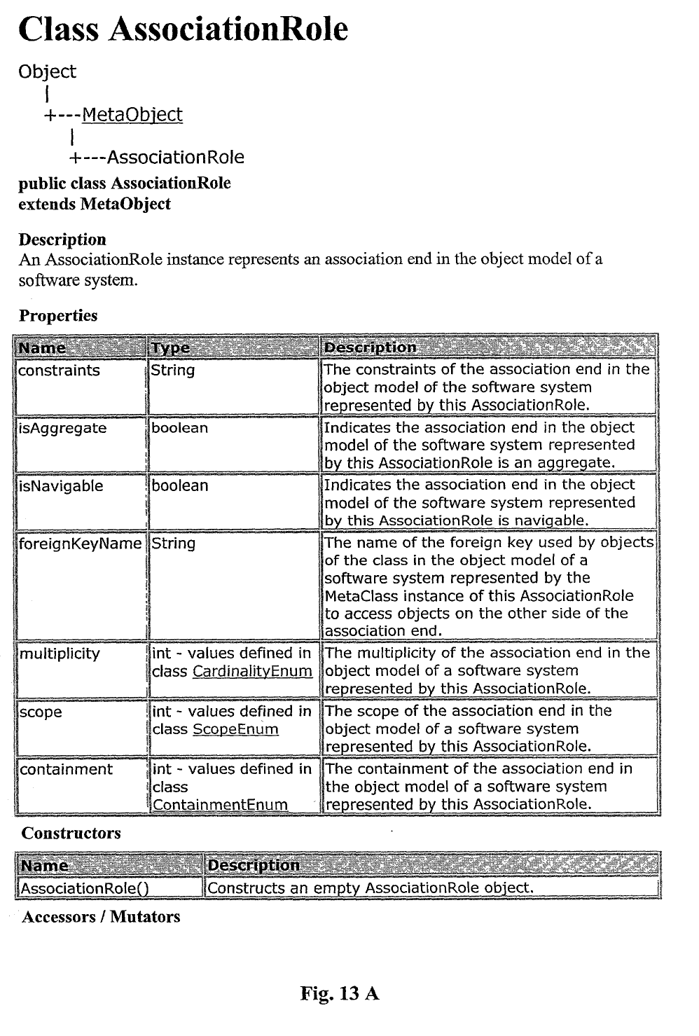

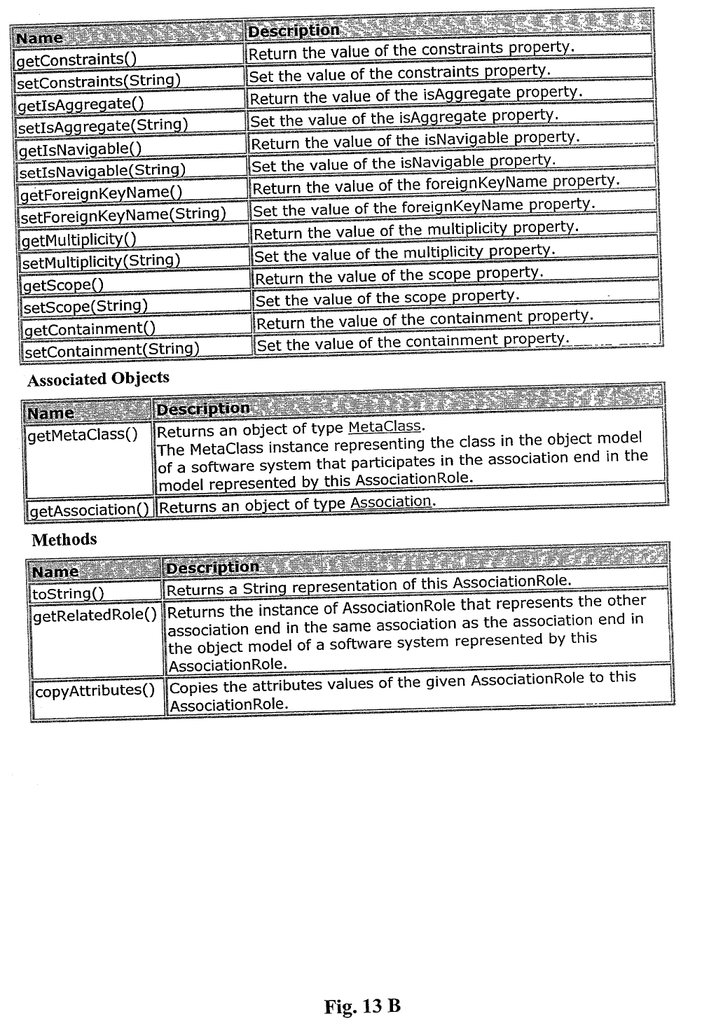

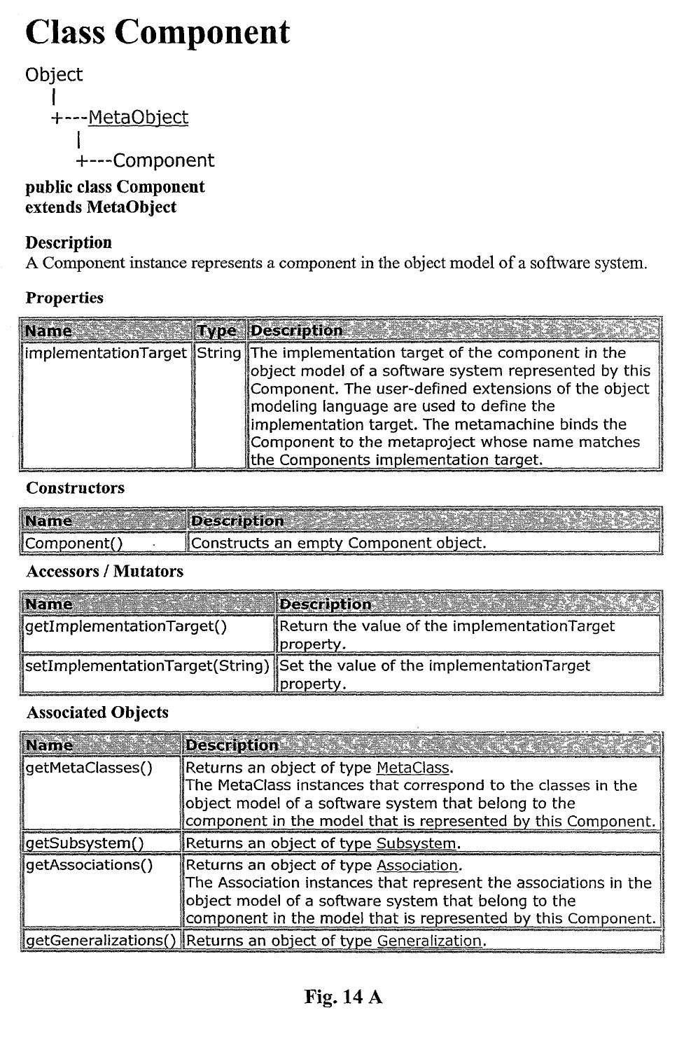

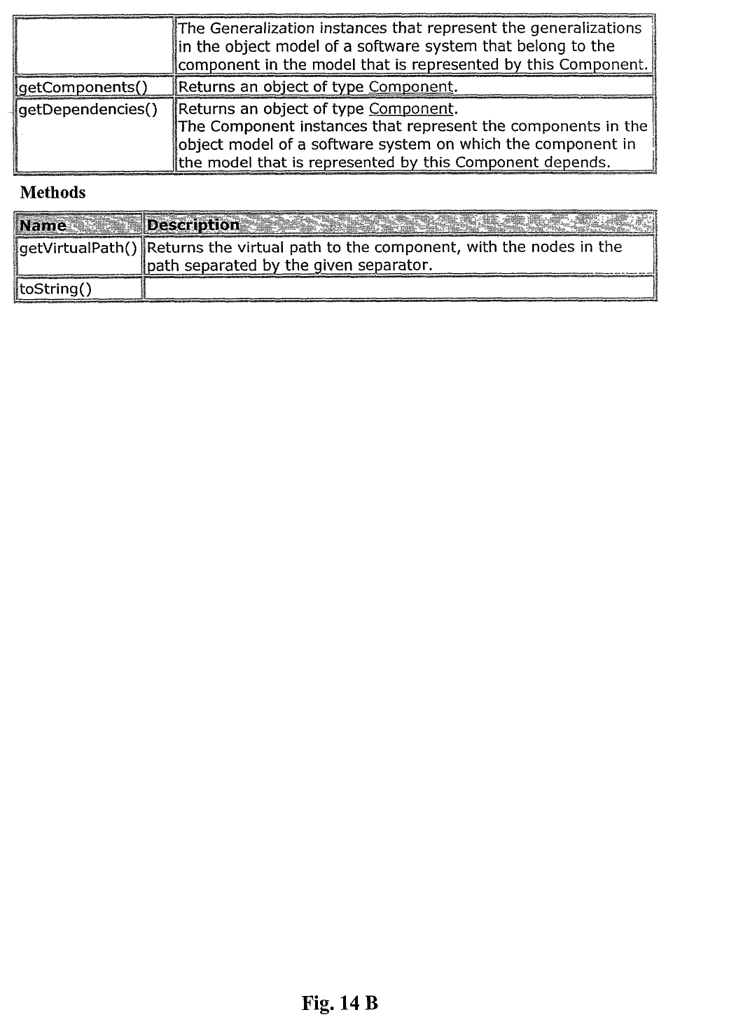

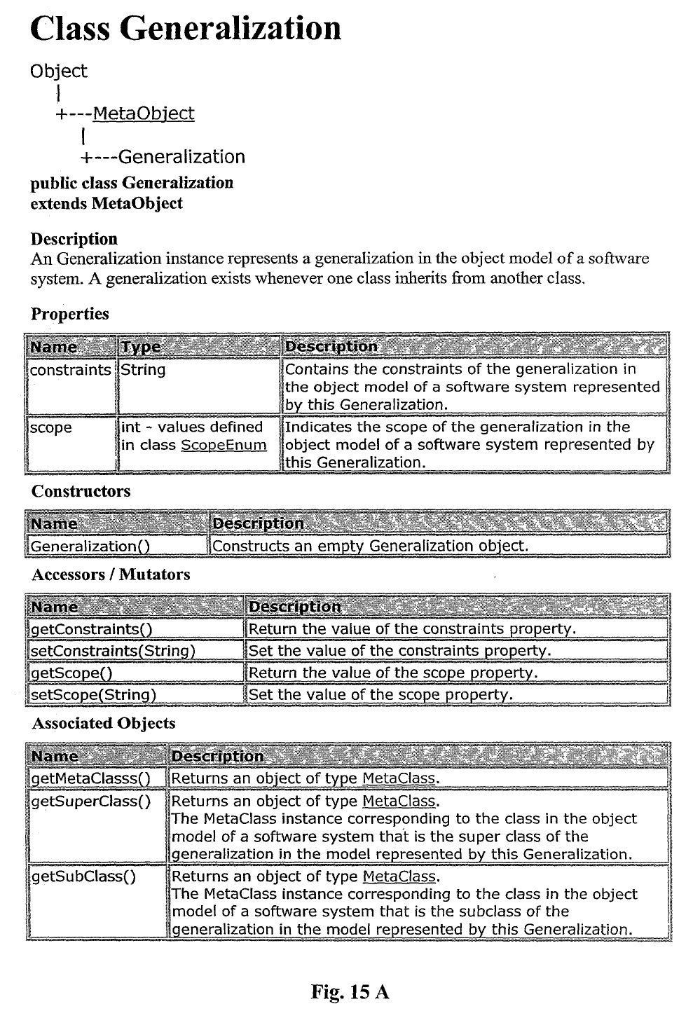

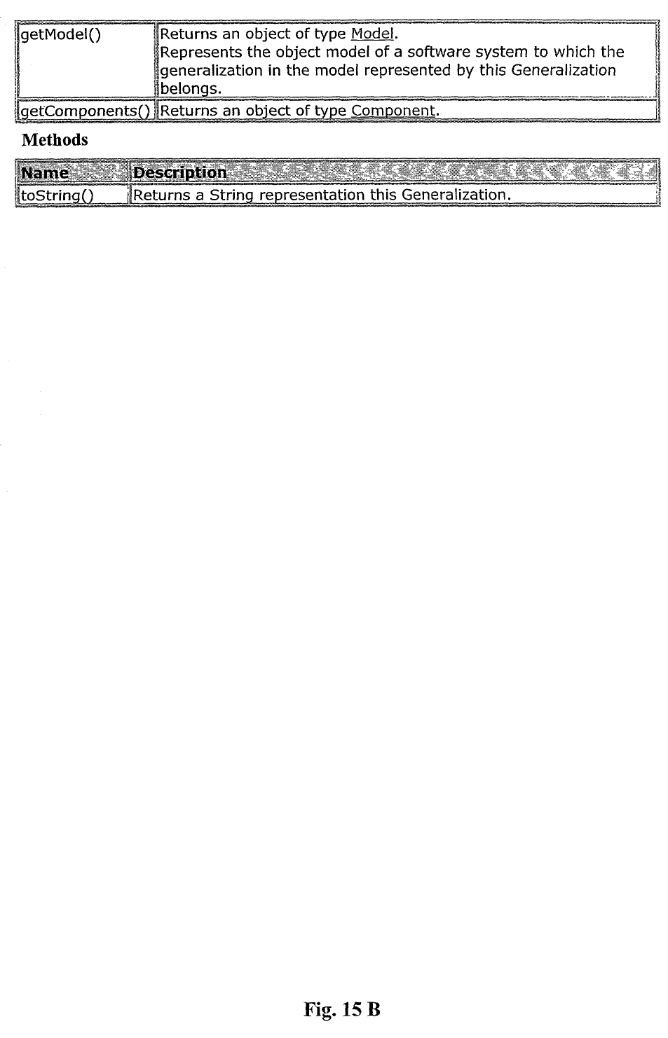

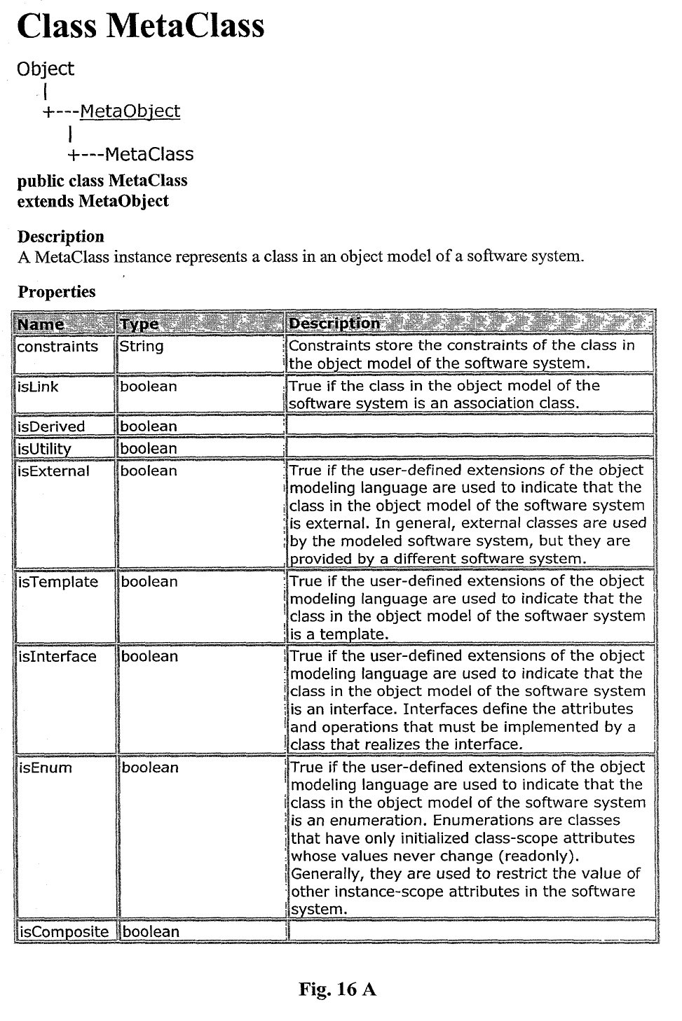

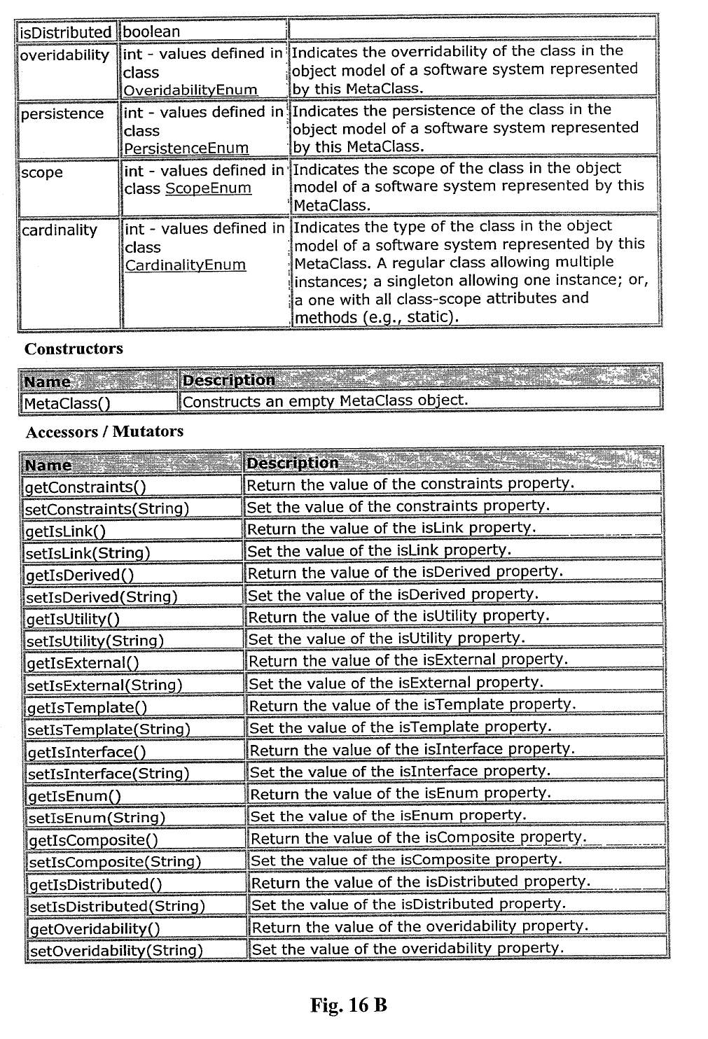

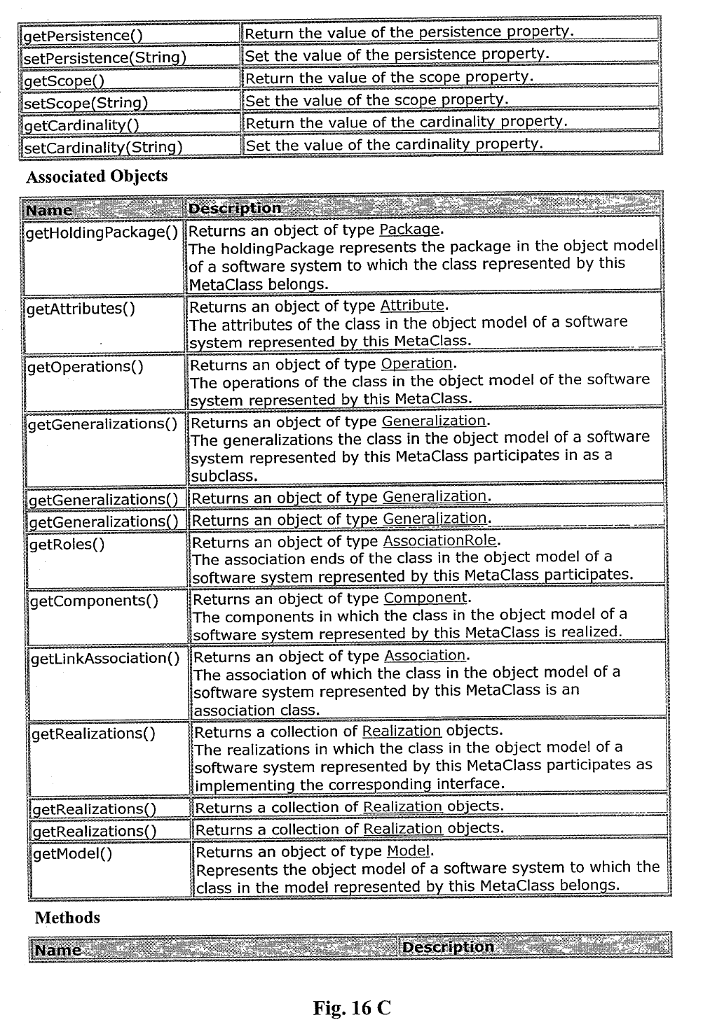

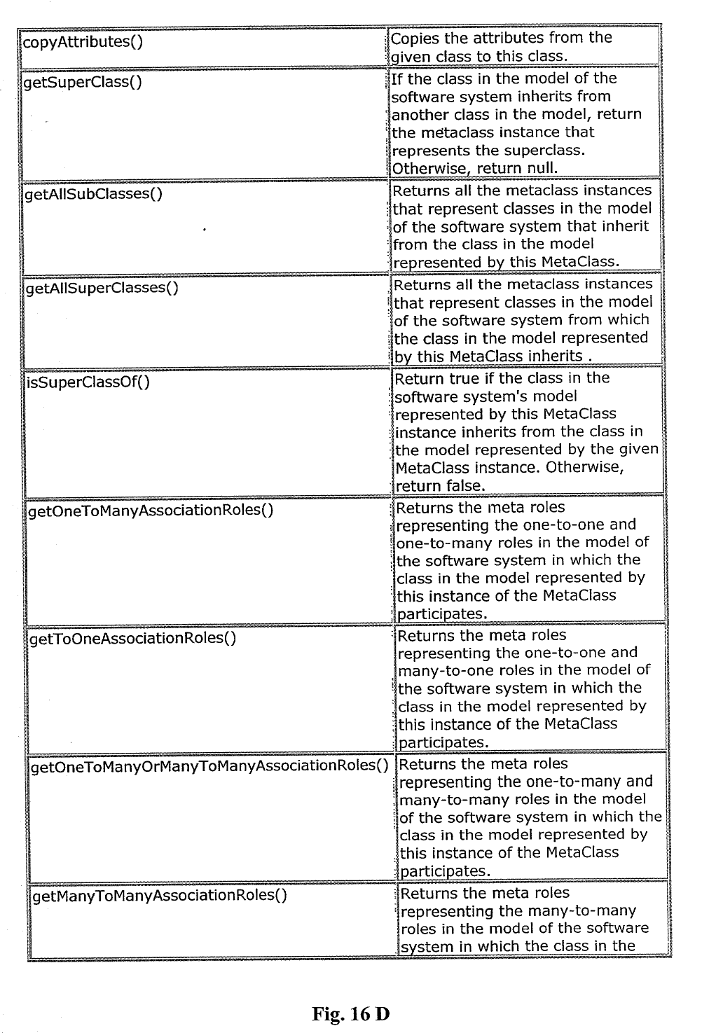

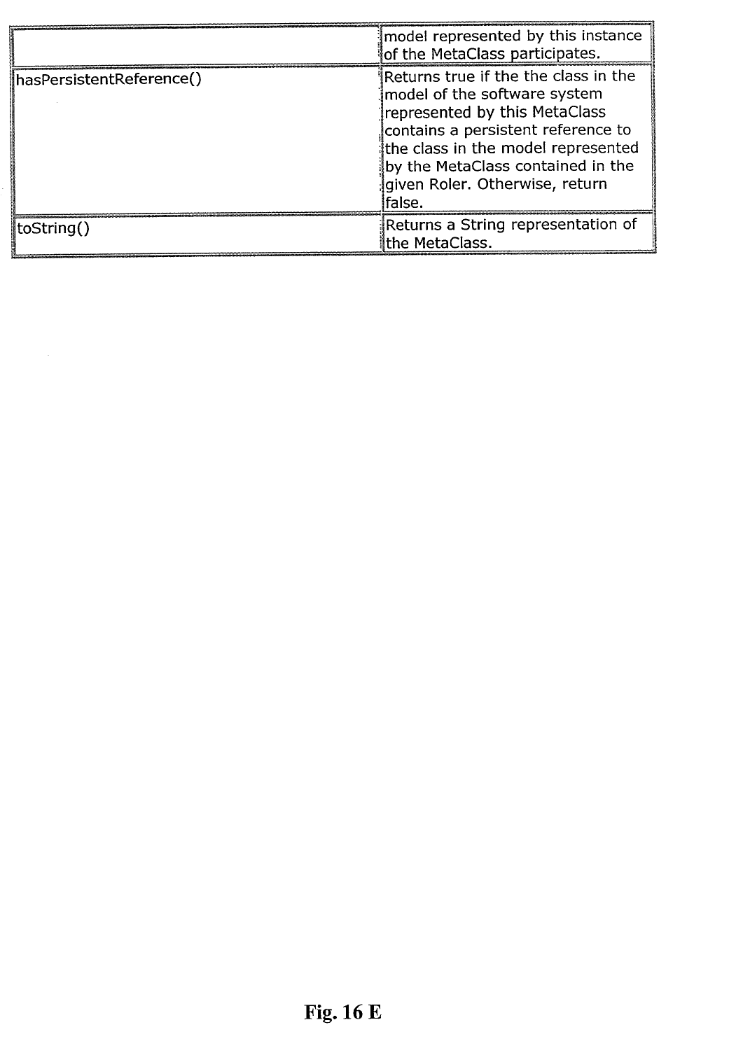

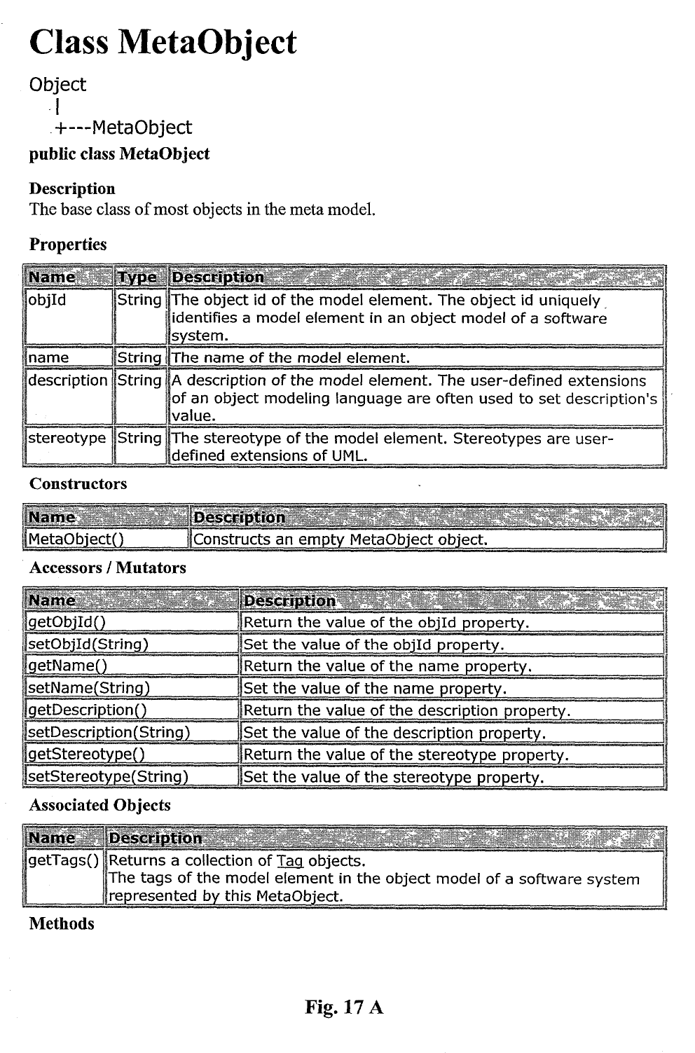

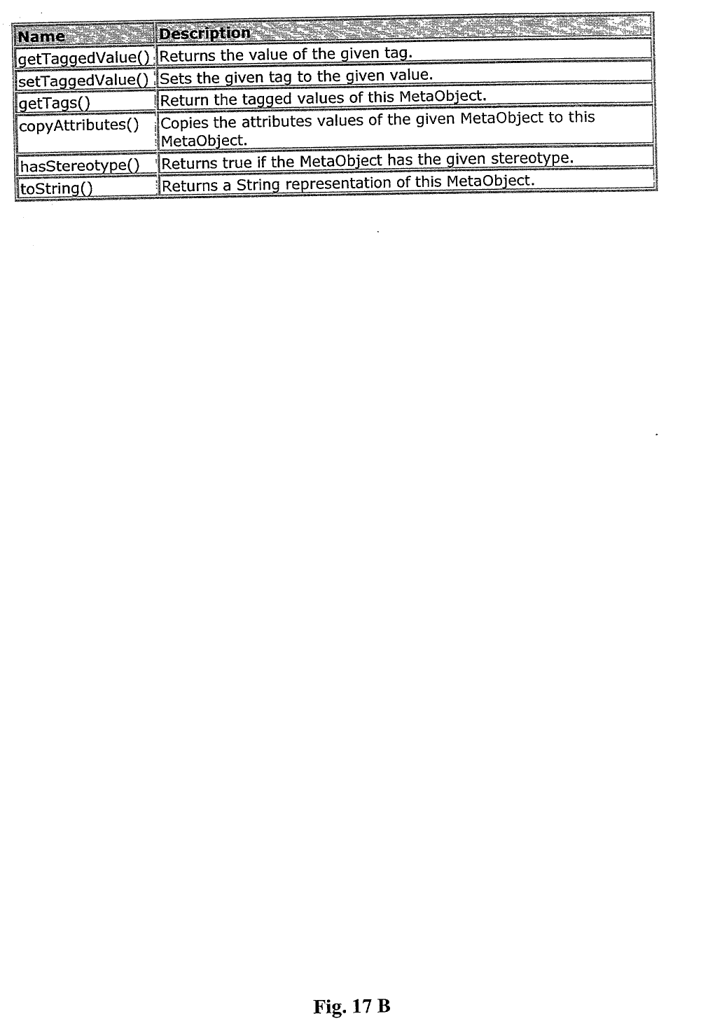

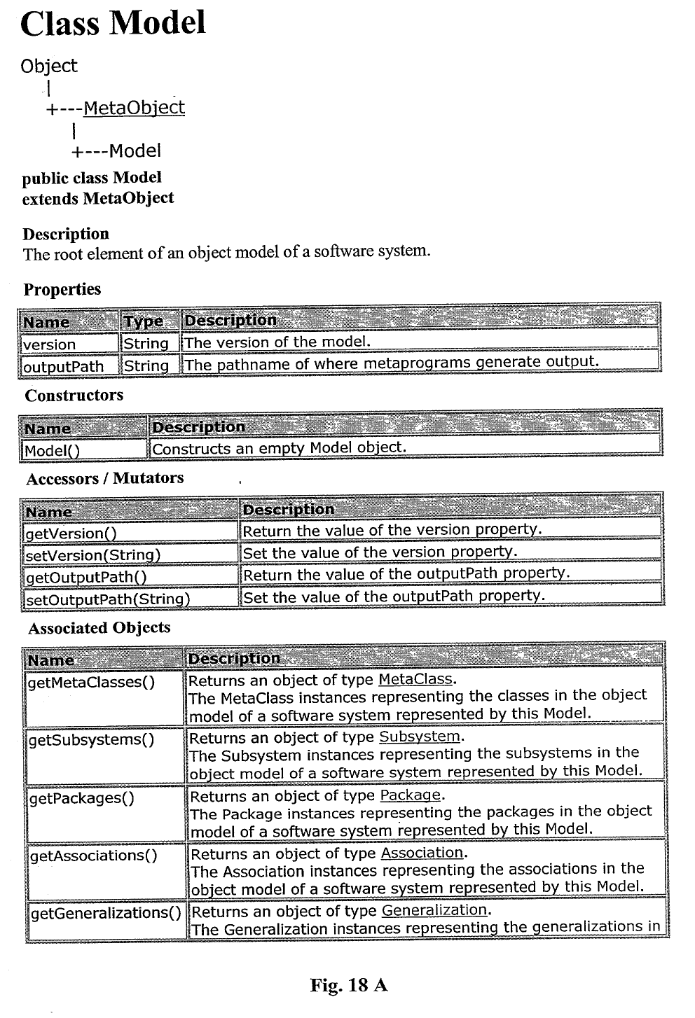

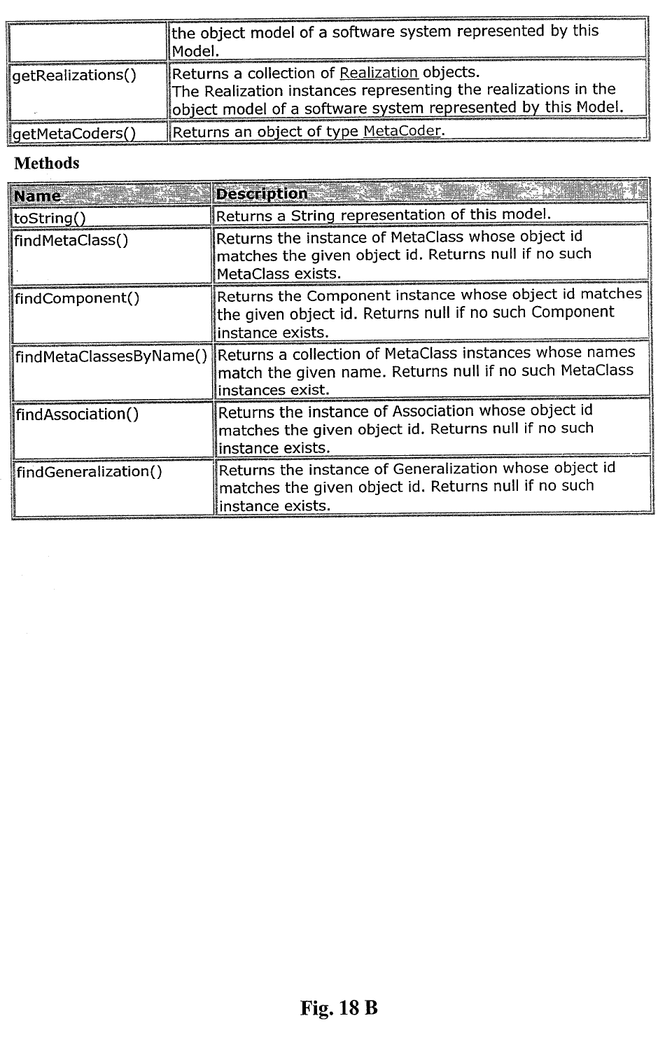

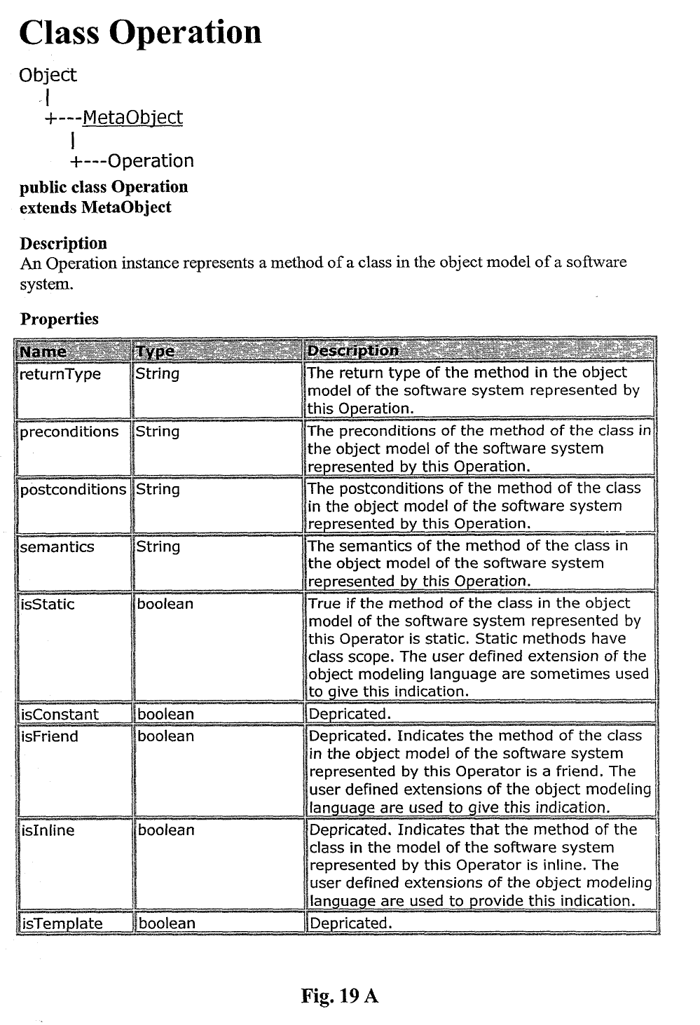

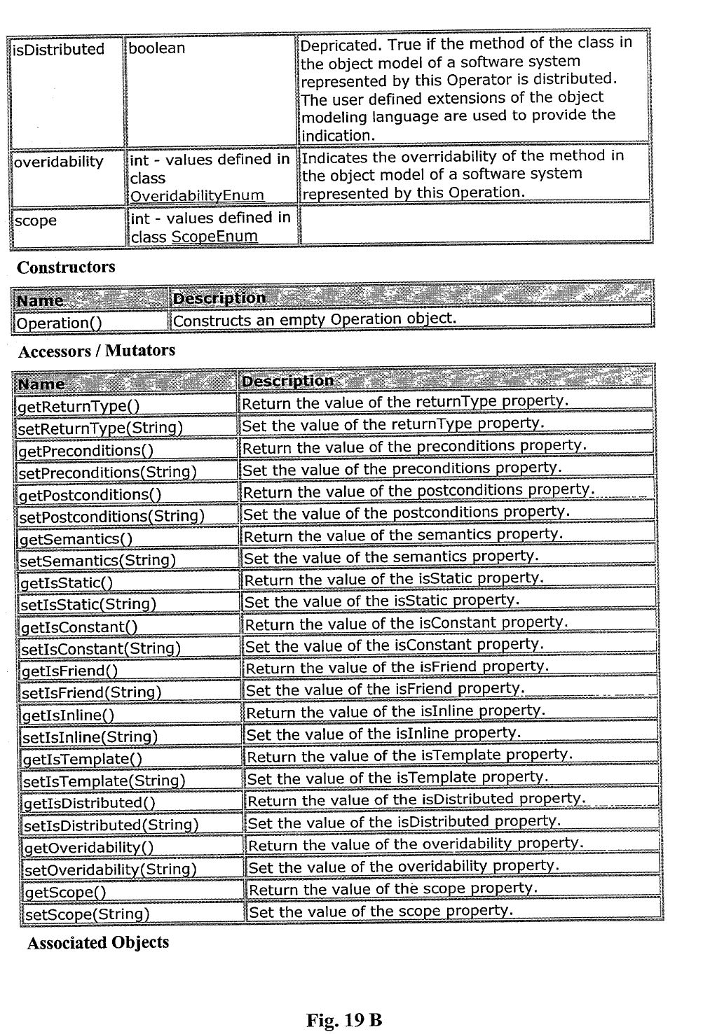

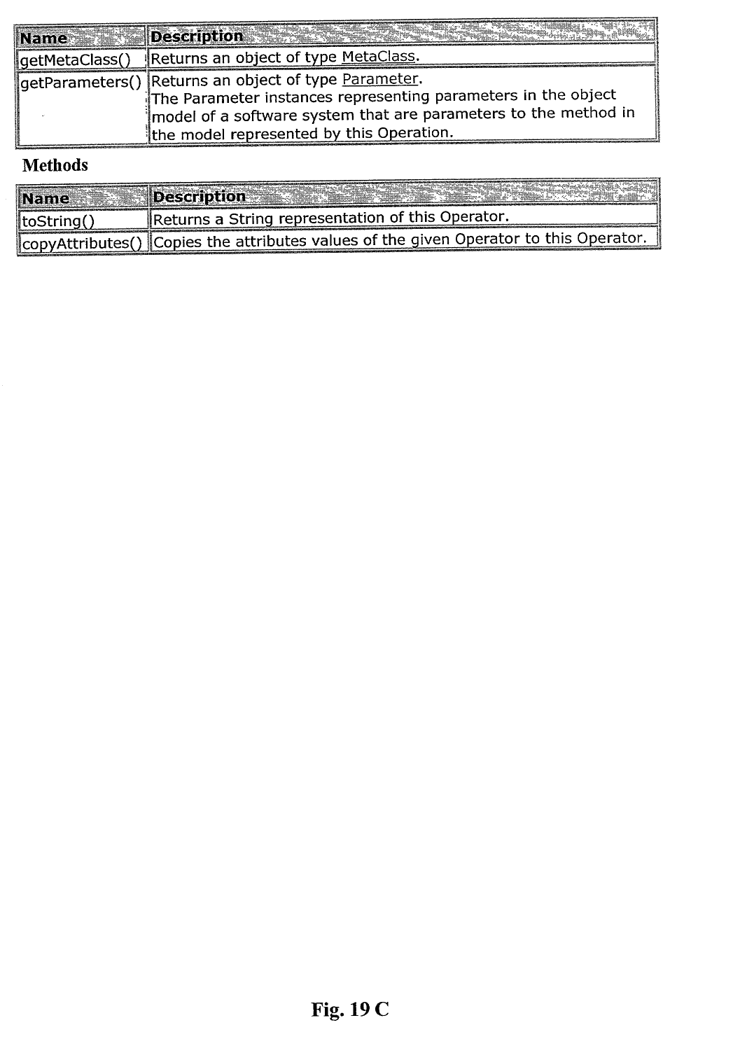

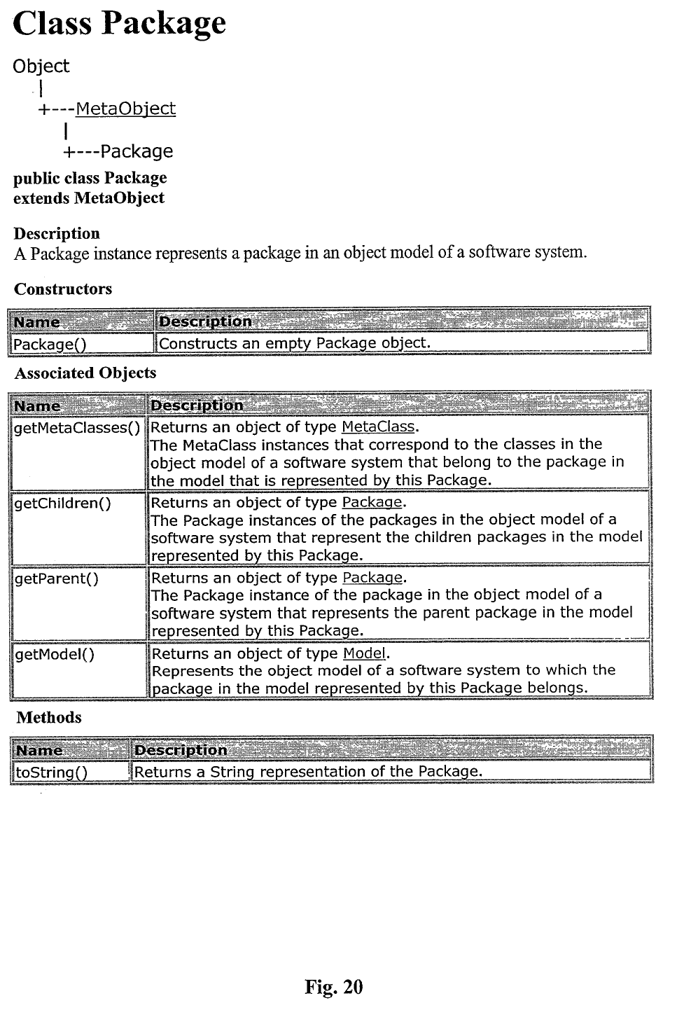

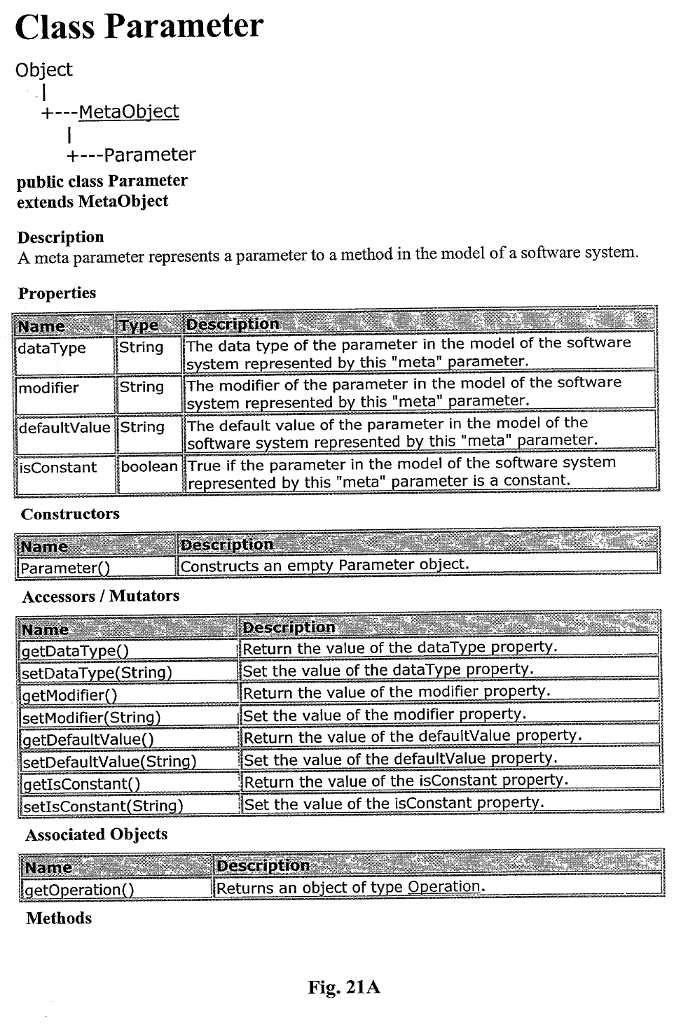

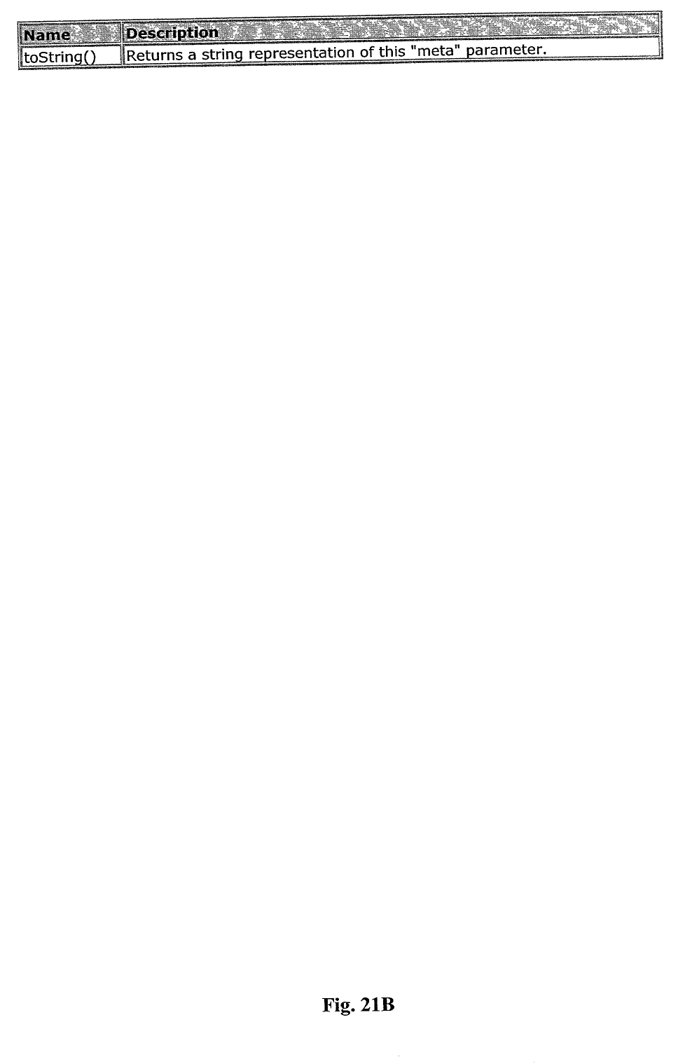

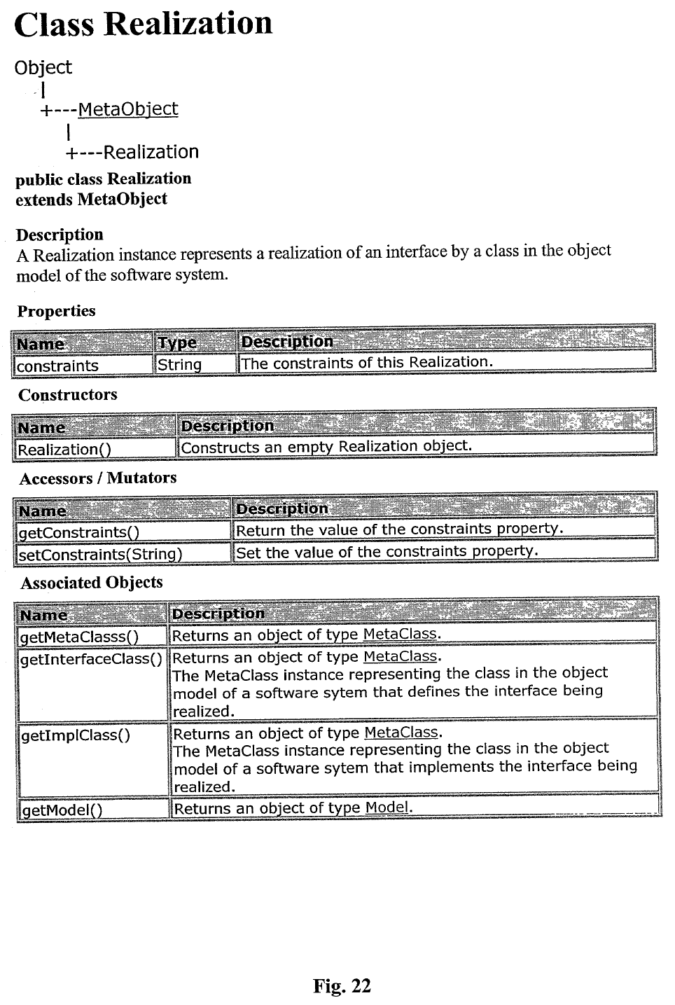

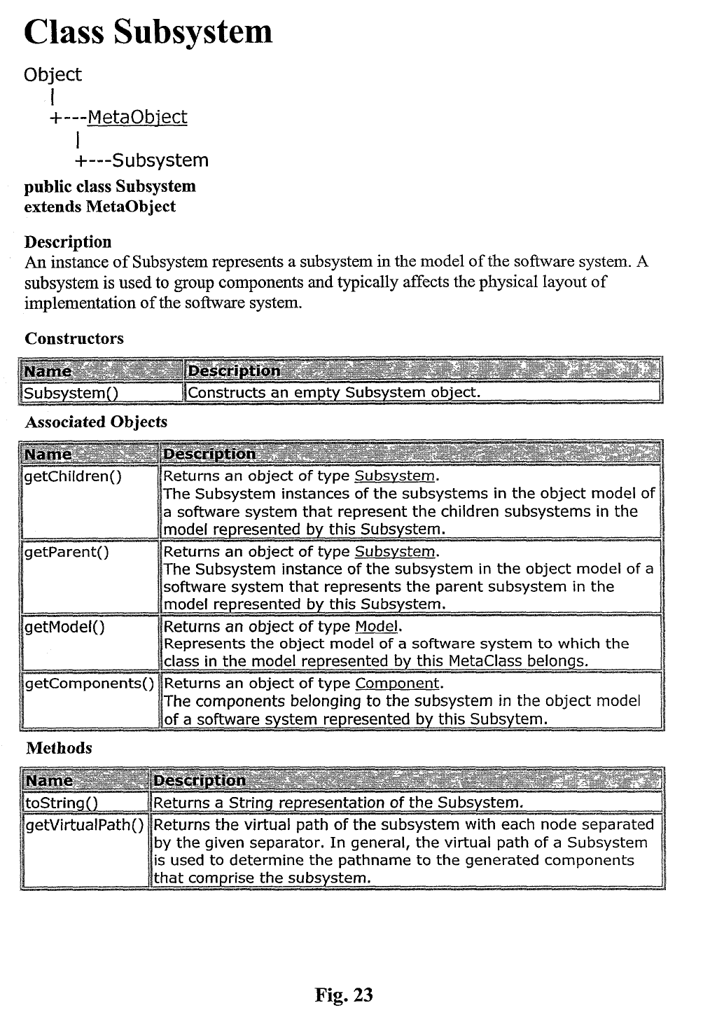

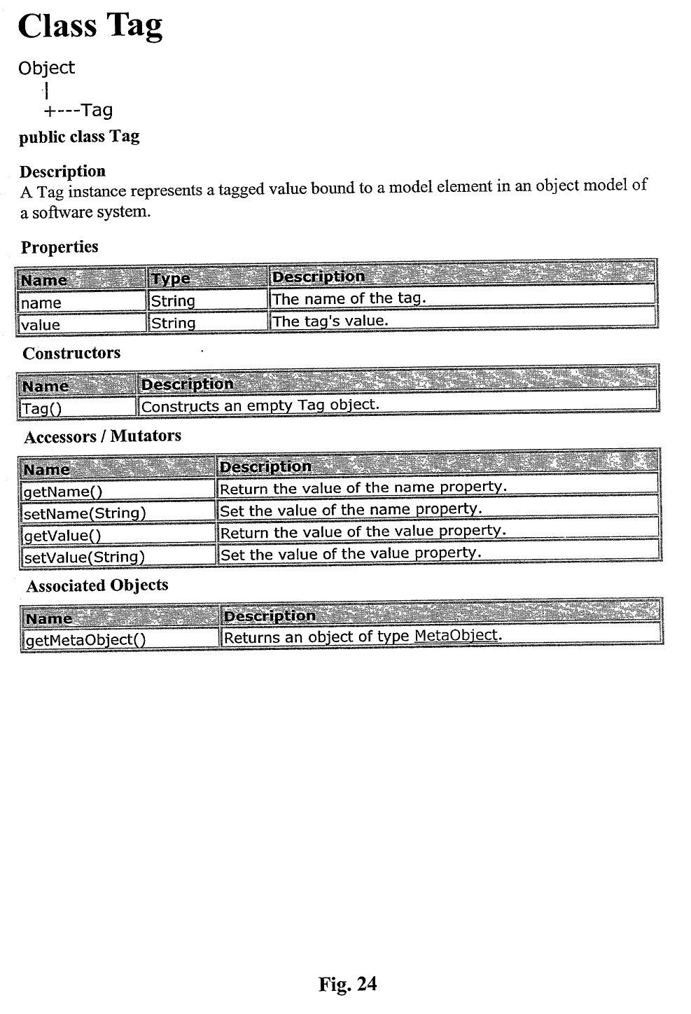

Complete descriptions of the above-referenced classes are provided in FIGS. 11A-24.

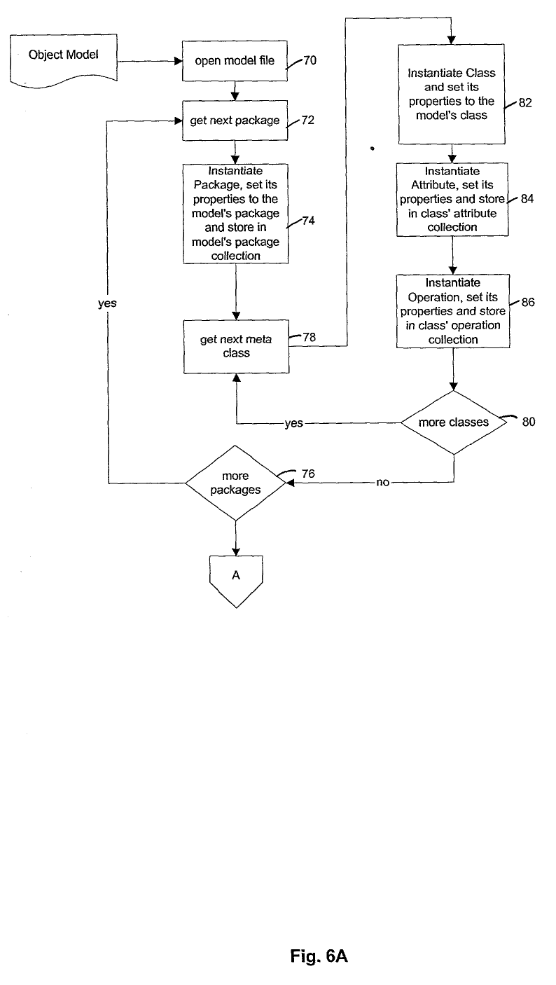

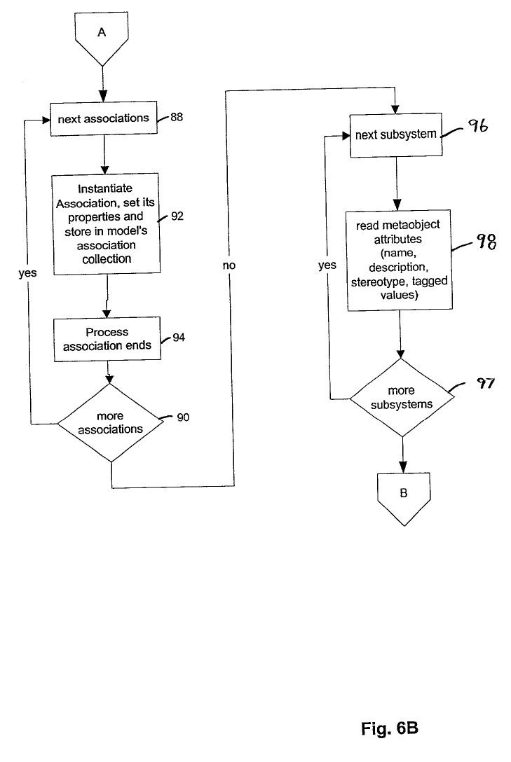

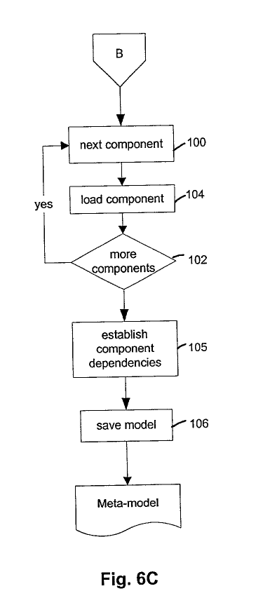

FIGS. 6A-C illustrate the process by which MDE 18 loads object model 12 into meta model 68. At step 70 MDE 18 opens the file embodying object model 12. As described above, object model 12 contains packages, subsystems, components and other elements. MDE 18 reads and processes these elements.

At step 72 MDE 18 finds a package in object model 12 that it has not yet processed in the loop between steps 72 and 76. At step 74 MDE 18 reads (package) meta-object attributes and processes the package. The processing includes:

instantiating an object of the Package class (“meta package” ); setting the stereotypes of the meta package to those of the package; setting the tag and value pairs of the meta package to those of the package; and adding the meta package to the collection of packages of meta model 68.

At step 78 MDE 18 finds a metaclass that it has not yet processed in the loop between steps 78 and 80. At step 82 MDE 18 reads and processes the class. This processing includes: instantiating an object of the Metaclass class (“meta class”); setting et the scope and name of the meta class to those of the class in object model 12; setting the meta class stereotypes to those of the class; setting the metaclass tags and values to those of the class; adding the new meta class object to the collection of metaclasses of meta model 68.

At step 84 MDE 18 loads all attributes of the class being processed into meta model 68. This loading includes, for each Attribute of the class: instantiating an object of the Attribute class (“meta attribute”); setting the scope, type, name and initial value of the meta attribute to those of the attribute in object model 12; setting the meta attribute stereotypes to those of the attribute; setting the meta attribute tags and values to those of the attribute; and adding the new attribute object to the collection of attributes of the metaclass.

At step 86 MDE loads all operations. This loading includes, for each method of the class: instantiating an object of the Operation class (“meta operation”); setting the scope, return type and name of the meta operation to those of the method in object model 12; setting the operation stereotypes to the method stereotypes; setting the operations tags and values to the methods tags and values. This loading step further includes, for each parameter of the method: instantiating an object of the Parameter class (“meta parameter”) and setting the type and name of the meta parameter to those of the parameter in object model 12; adding the meta parameter to the collection of parameters for the meta operation; and adding the new operation object to the collection of operations of the metaclass.

When all packages and all classes in those packages have been processed, at step 88 MDE 18 finds an association it has not yet processed in the loop between steps 88 and 90. At step 92 MDE 18 reads (association) meta-object attributes and processes the association. For each association in object model 12, this processing includes: instantiating an object of the Association class (“meta association”); setting the name of the meta association to that of the association in object model 12; setting the stereotypes of the meta association to those of the association; setting the tags and values of the meta association to those of the association; adding the new meta association object to the collection of associations of meta model 68; and instantiating an AssociationRole object (“meta role”) for each association end. The processing further includes, for each meta role: setting the stereotypes of the meta role to those of the association end; setting the tags and values of the meta role to those of the association end; setting the meta class of the meta role to the MetaClass instances in the collection of metaclasses in object model 12 representing the class participating in the association end; setting the related role of each meta role to the other meta role; and adding the meta association to the collection of associations of meta model 68.

At step 94 MDE 18 loads association roles into object model 68. This loading step includes: instantiating an object of the AssociationRole class (“meta association role”); setting the name of the meta association role to that of the association role in object model 12; setting the stereotypes of the meta association role to those of the association; setting the tags and values of the meta association role to those of the association; adding the new meta association role object to the collection of associations of meta model 68; and instantiating an AssociationRole object (“meta role”) for each association role. The processing further includes, for each meta role: setting the stereotypes of the meta role to those of the association end; setting the tags and values of the meta role to those of the association end; setting the meta class of the meta role to the MetaClass instances in the collection of metaclasses in object model 12 representing the class participating in the association end; setting the related role of each meta role to the other meta role; and adding the meta association to the collection of associations of meta model 68.

When all associations have been processed, at step 96 MDE 18 finds a subsystem it has not yet processed in the loop between steps 96 and 97. At step 98 MDE 18 reads and processes the subsystem. For each subsystem in object model 12, the processing includes: instantiating a Subsystem object (“meta subsystem”); setting the name of the meta subsystem to that of the subsystem in object model 12; setting the stereotypes of the meta subsystem to those of the subsystem; setting the tags and values of the meta subsystem to those of the subsystem; adding the new meta subsystem object to the collection of subsystems of meta model 68.

When all subsystems have been processed, at step 100 MDE 18 finds a component it has not yet processed in the loop between steps 100 and 102. At step 104 MDE 18 loads the component into object model 68. For each component in the software system's model, this loading step includes: instantiating a Component object (“meta component”); setting the name of the meta component to that of the component in object model 12; setting the stereotypes of the meta component to those of the component; and setting the tags and values of the meta component to those of the component. The processing further includes, for each class realized in the component, getting the meta class corresponding to the class in object model 12 for the collection of meta classes of meta model 68 and adding it to the collection of meta classes of the component.

At step 105 MDE 18 establishes component dependencies. For each meta component in the collection of meta components of meta model 68, this processing includes: getting the components in the object model 12 on which the meta component depends and, for each such component gotten, get the corresponding meta component and add this meta component to the dependencies collection of the meta component being processed.

When all components have been processed, at step 106 MDE 18 then completes the loading process by saving the loaded meta model 68 (e.g., to disk 28). MDE 18 also displays a graphical representation (not shown) of the loaded meta model 68 in project panel 50.

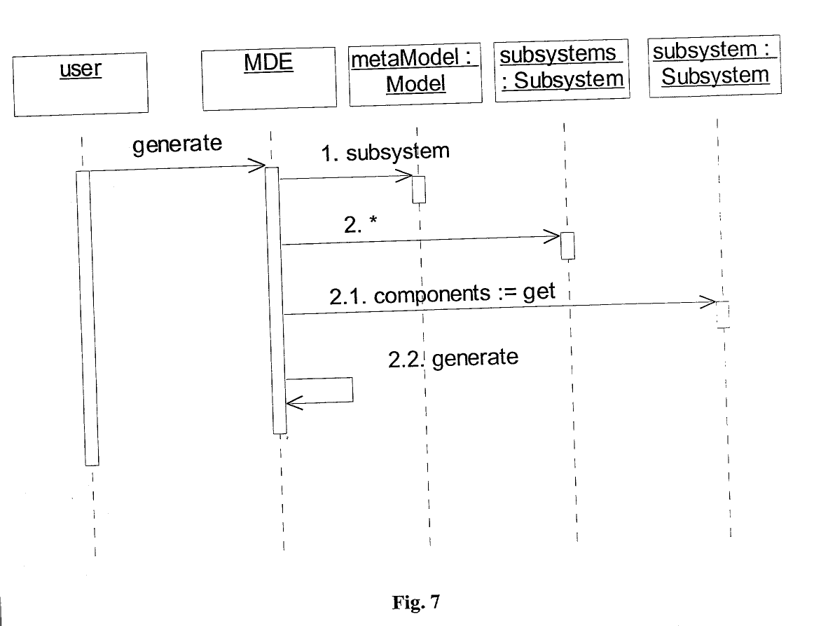

When object model 12 has been selected and loaded into meta model 68 and a set of one or more metaprograms 14 has been selected, loaded and compiled as described above, the user can initiate the operation that causes MDE 18 to generate software system 16. FIGS. 7-9 are UML sequence diagrams illustrating this operation.

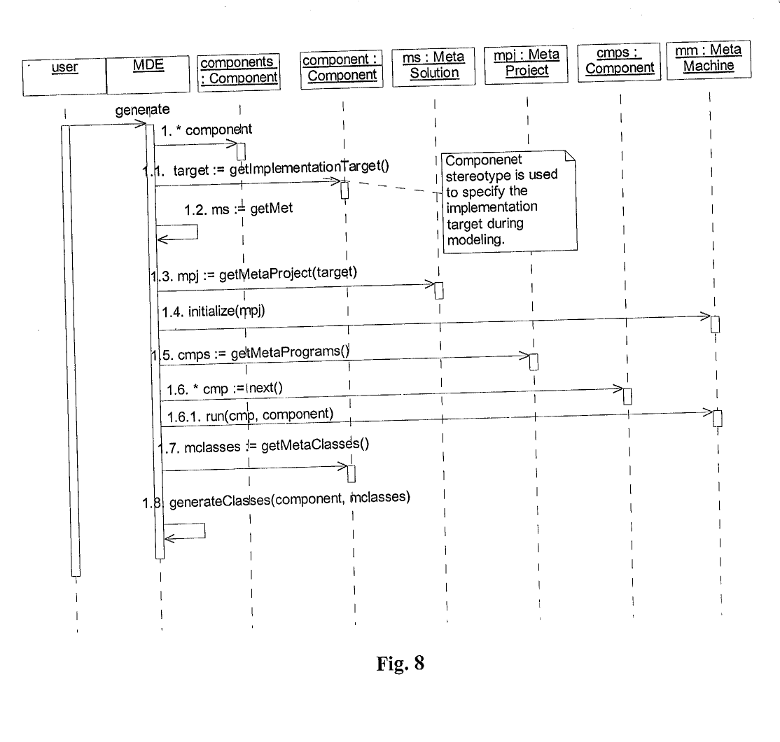

Within the project explorer of the user interface, the user right clicks “Subsystems” and selects “Build.” At this point, meta-machine 10 performs the following steps shown in FIG. 7. First, MDE 18 retrieves all subsystems in the current model. Then, for each subsystem in the model, MDE 18 performs the following steps: retrieve the components in the subsystem; and generate each component, as further explained below with reference to FIG. 8.

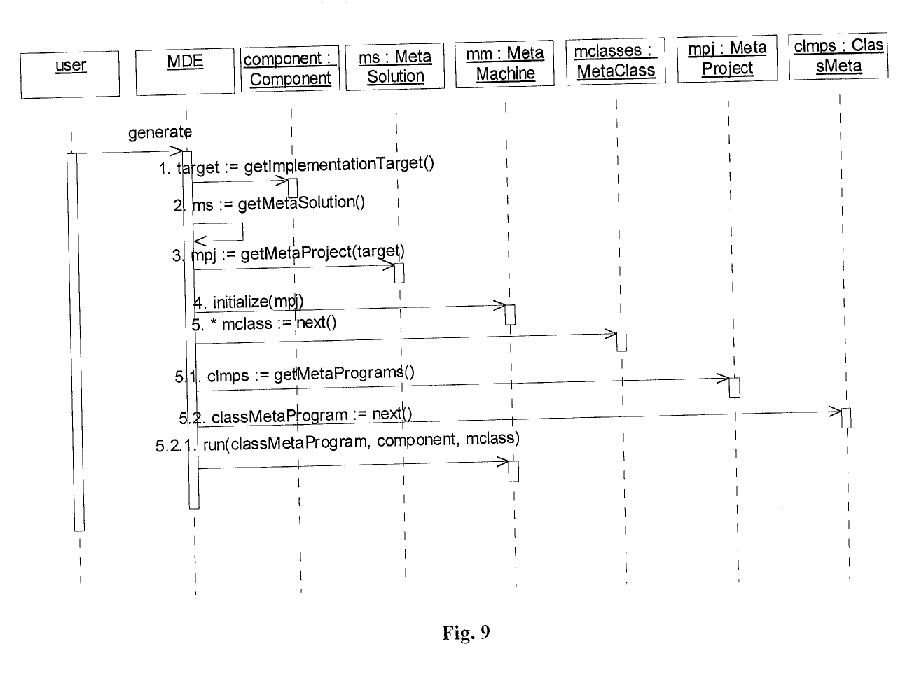

As illustrated in FIG. 8, for each component to generate, MDE 18 retrieves the implementation target from the component. The implementation target is a stereotype of the component and binds the component to a metaproject. MDE 18 then: retrieves the current set of metaprograms (“metasolution”); retrieves the metaproject whose name matches the implementation target of the component; initializes meta-machine 10; and retrieves the component metaprograms in the metaproject. For each component metaprogram, MDE 18 instructs meta-machine 10 to run the component metaprogram. MDE 18 then retrieves the meta-classes in the component and invokes the appropriate class metaprograms, as further explained below with reference to FIG. 9.

As illustrated in FIG. 9, MDE 18 retrieves the implementation target from the component for which it has been invoked. The implementation target is a stereotype applied to the component and binds the component to a metaproject. MDE 18 then retrieves the current set of metaprojects for the loaded metasolution. MDE 18 retrieves the metaproject associated with the component and initializes meta-machine 10 with the metaproject. All the metaprograms 14 in the metaproject are, in effect, loaded into meta-machine 10. Then, for each meta-class in the component, MDE 18 retrieves the class metaprograms associated with the metaproject to which the component is bound and retrieves the next class metaprogram in the metaproject.

In view of the foregoing, it can be seen that by separating architecture from application the present invention overcomes the problems and deficiencies in the prior art that have increasingly hampered efficient software development and maintenance.

Using the present invention as described above, applications for software systems can be developed and maintained in a modeling language independently of architectures, and architecture-dependent aspects of software systems can be developed and maintained independently of applications. Among other advantages, this independence can allow business analysts and other non-technologists to more efficiently focus upon the applications in which they have expertise and leave the architecture-dependent metaprogramming to programmers and other technologists.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for developing a software system, comprising the steps of:
providing an object model expressed in an object modeling computer language, the object model representing a software system and comprising components realizing classes;
providing a set of one or more metaprograms reflecting a computer system architecture; and
a meta-machine binding the components to the metaprograms to generate the software system for a computer system having said architecture.

2. The method claimed in claim 1, wherein the object modeling computer language is the Unified Modeling Language (UML).

3. The method claimed in claim 1, wherein:
the step of providing an object model is performed in part by a business analyst creating the object model; and
the step of providing a set of one or more metaprograms is performed in part by a technologist coding the metaprograms.

4. The method claimed in claim 1, wherein:
the step of providing an object model comprises a user using a graphical user interface to list a project in a first window, the project representing the object model; and
the step of providing one or more metaprograms comprises a user using a graphical user interface to list one or more metaprojects in a second window, each metaproject including a list of representations of the metaprograms.

5. The method claimed in claim 4, wherein the object modeling computer language includes an extension mechanism for the specification of user-defined properties and the assignment of these properties and their values to elements of the object model.

6. The method claimed in claim 5, wherein:
the object modeling computer language is the Unified Modeling Language (UML); and
the user-defined extension mechanism is a Stereootype.

7. The method claimed in claim 5, wherein:
the object modeling computer language is the Unified Modeling Language (UML); and
the user-defined extension mechanism is Tagged Values.

8. The method claimed in claim 5, wherein the step of a meta-machine binding the components to the metaprograms comprises the steps of:
searching the list of metaprojects for a metaproject having a name matching a name of an implementation target, wherein the implementation target is defined by the user-defined extension mechanism associated with the components; and
storing an indication of an association between the metaproject having the matching name with metaprograms of which representations are listed in the metaproject having the matching name.

9. The method claimed in claim 8, wherein:
the object modeling computer language is the Unified Modeling Language (UML);
the user-defined extension mechanism is a Stereootype; and
the Stereotype indicates the implementation target.

10. The method claimed in claim 8, wherein:
the object modeling computer language is the Unified Modeling Language (UML);
the user-defined extension mechanism is Tagged Values; and
the Tagged Values indicate the implementation target.

11. The method claimed in claim 1, further comprising the step of a user using a graphical user interface to invoke a metaprogram editor.

12. The method claimed in claim 1, wherein each metaprogram in said set of metaprograms includes code and metacode, and the metacode generates a portion of the source code of the software system by outputting the code.

13. The method claimed in claim 12, further comprising the step of a user using a graphical user interface to invoke a metaprogram editor.

14.The method claimed in claim 13, further comprising the step of a user activating a toggling function of the metaprogram editor to toggle a window between highlighting the code and highlighting the metacode.

15. The method claimed in claim 1, wherein the set of metaprograms includes a model metaprogram that modifies the object model.

16. The method claimed in claim 1, wherein the set of metaprograms includes a component metaprogram invoked once for each component and uses the classes realized by the component to produce a portion of the software system.

17. The method claimed in claim 1, wherein the set of metaprograms includes a class metaprogram that is invoked once for each class realized in each component and that produces a portion of the software system.

18. A meta-development environment computer program product for developing a software system, the computer program product comprising a computer-readable medium carrying thereon:
a meta-machine responsive to an object model and a set of one or more metaprograms input to the meta-machine under control of a user, the object model expressed in an object modeling computer language, the object model representing a software system and comprising components realizing object classes, the set of metaprograms reflecting a computer system architecture, the meta-machine under control of the user binding the components to the metaprograms to generate a resultant software system executable on a computer system having the architecture; and
a user interface for providing user control of metaprogram input, object model input, meta-machine operation, and resultant software system output.

19. The computer program product claimed in claim 18, wherein the object modeling computer language is the Unified Modeling Language (UML).

20. The computer program product claimed in claim 18, wherein the user interface comprises a graphical user interface listing a project in a first window, the project representing the object model, and listing one or more metaprojects in a second window, each metaproject including a list of representations of the metaprograms.

21. The computer program product claimed in claim 20, wherein the object modeling computer language includes an extension mechanism for the specification of user-defined properties and the assignment of these properties and their values to elements of the object model.

22. The computer program product claimed in claim 21, wherein:
the object modeling computer language is the Unified Modeling Language (UML); and
the user-defined extension mechanism is a Stereootype.

23. The computer program product claimed in claim 21, wherein:
the object modeling computer language is the Unified Modeling Language (UML); and
the user-defined extension mechanism is Tagged Values.

24. The computer program product claimed in claim 21, wherein the meta- machine binds the components to the metaprograms by searching the list of metaprojects for a metaproject having a name matching a name of an implementation target and storing an indication of an association between the metaproject having the matching name with metaprograms of which representations are listed in the metaproject having the matching name, wherein the implementation target is defined by the user-defined extension mechanism associated with the components.

25. The computer program product claimed in claim 24, wherein:
the object modeling computer language is the Unified Modeling Language (UML);
the user-defined extension mechanism is a Stereotype; and
the Stereotype indicates the implementation target.

26. The computer program product claimed in claim 24, wherein:
the object modeling computer language is the Unified Modeling Language (UML);
the user-defined extension mechanism is Tagged Values; and
the Tagged Values indicate the implementation target.

27. The computer program product claimed in claim 18, wherein the user interface includes a metaprogram editor.

28. The computer program product claimed in claim 18, wherein each metaprogram in said set of metaprograms includes code and metacode, and the metacode generates a portion of the source code of the software system by outputting the code.

29. The computer program product claimed in claim 28, wherein the user interface includes a metaprogram editor.

30. The computer program product claimed in claim 29, wherein the metaprogram editor includes a toggling means for toggling a window between highlighting the code and highlighting the metacode.

31. The computer program product claimed in claim 18, wherein the set of metaprograms includes a model metaprogram that modifies the object model.

32. The computer program product claimed in claim 18, wherein the set of metaprograms includes a component metaprogram invoked once for each component and uses the classes realized by the component to produce a portion of the software system.

33. The computer program product claimed in claim 18, wherein the set of metaprograms includes a class metaprogram that is invoked once for each class realized in each component and that produces a portion of the software system.

34. A method for developing software systems for a plurality of computer system architectures, comprising the steps of:
providing a meta-development environment (MDE) to a first party having access to a first computer system with a first architecture;
providing the MDE to a second party having access to a second computer system with a second architecture;
providing the first party's MDE with an object model expressed in an object modeling computer language, the object model representing a software system and comprising components realizing classes;
providing the second party's MDE with the object model;
providing the first party's MDE with a first set of one or more metaprograms reflecting the first architecture, wherein binding in the MDE of the components of the object model and the first set of metaprograms defines first software system code executable on a computer system having the first architecture but not executable on a computer system having the second architecture, the first software system code effecting a user application when executed on the first computer system; and
providing the second party's MDE with a second set of one or more metaprograms reflecting the second architecture, wherein binding in the MDE of the components of the object model and the second set of metaprograms defines second software system code executable on a computer system having the second architecture but not executable on a computer system having the first architecture, the second software system code effecting the same user application when executed on the second computer system as the first software system code effects when executed on the first computer system.

35. The method claimed in claim 34, wherein:
the MDE includes a metaprogram editor and a meta-machine;
the step of providing the first party's MDE with a first set of one or more metaprograms includes the step of the first party using the metaprogram editor of the first party's MDE to write metaprogram code; and
the step of providing the second party's MDE with a second set of one or more metaprograms includes the step of the second party using the metaprogram editor of the second party's MDE to write metaprogram code.

36. The method claimed in claim 35, wherein the object modeling computer language is the Unified Modeling Language (UML).

37. The method claimed in claim 35, wherein:
the step of providing the first party's MDE with an object model comprises the first party purchasing the object model from a vendor and loading the object model into the first party's MDE; and
the step of providing the second party's MDE with an object model comprises the second party purchasing the same object model from a vendor and loading the object model into the second party's MDE.

38. A method for developing software systems for a plurality of computer system architectures, comprising the steps of:
providing a meta-development environment (MDE) to a first party having access to a first computer system having an architecture;
providing the MDE to a second party having access to a second computer system having the architecture;
the first party writing a first object model expressed in an object modeling computer language and loading the first object model into the first party's MDE, the object model representing a first software system and comprising components realizing classes;
the second party writing a second object model expressed in an object modeling computer language and loading the second object model into the second party's MDE, the object model representing a second software system and comprising components realizing classes;
the first party purchasing from a vendor a set of one or more metaprograms reflecting the architecture and loading the set of metaprograms into the first party's MDE, wherein binding in the MDE of the components of the first object model and the set of metaprograms defines first software system code executable on a computer system having the architecture but not executable on a computer system having another architecture, the first software system code effecting a first user application when executed on the first computer system; and
the second party purchasing from a vendor a set of one or more metaprograms reflecting the architecture and loading the set of metaprograms into the second party's MDE, wherein binding in the MDE of the components of the second object model and the set of metaprograms defines second software system code executable on a computer system having the architecture but not executable on a computer system having another architecture, the second software system code effecting a second user application when executed on the second computer system different from that which the first software system code effects when executed on the first computer system.

39. The method claimed in claim 38, wherein the object modeling computer language is the Unified Modeling Language (UML).

40. The method claimed in claim 38, wherein:
the step of the first party writing a first object model comprises a business analyst writing the first object model; and
the step of the second party writing a second object model comprises a business analyst writing the second object model.
